(19) United States
(12) Patent Application Publication
(10) Pub. No.: US 2023/0316273 A1
(43) Pub. Date: Oct. 5, 2023

(54) DATA PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventors: Gengliang ZHU, Shenzhen (CN); Hu LAN, Shenzhen (CN); Zongyou WANG, Shenzhen (CN); Yifang SHI, Shenzhen (CN); Zhiyong LIAO, Shenzhen (CN); Qucheng LIU, Shenzhen (CN); Pan LIU, Shenzhen (CN); Kaiban ZHOU, Shenzhen (CN); Huankun HUANG, Shenzhen (CN); Jinsong ZHANG, Shenzhen (CN); Hanqing LIU, Shenzhen (CN)

(21) Appl. No.: 18/206,028

(22) Filed: Jun. 5, 2023

Related U.S. Application Data
(63) Continuation of application No. PCT/CN2022/105391, filed on Jul. 13, 2022.

(30) Foreign Application Priority Data
Aug. 23, 2021 (CN) 202110965200.0

(51) Int. Cl. G06Q 20/38

(52) U.S. Cl. CPC G06Q 20/389; G06Q 20/3825

(57) ABSTRACT

A data processing method is performed by a computer device acting as a target consensus node in a core consensus network, and includes: receiving a transaction and a target chain identifier transmitted by a service node, the target chain identifier belonging to M chain identifiers configured for the service node; performing packing processing on the transaction based on a derivation condition corresponding to the target chain identifier to obtain a to-be-verified block, and transmitting the to-be-verified block to at least a part of consensus nodes in the core consensus network except the target consensus node based on the target chain identifier; and receiving a first block consensus result returned by the consensus node, and writing, when the first block consensus result indicates that consensus succeeds, the to-be-verified block to a service branch chain corresponding to the target chain identifier.

### CROSS-REFERENCE TO RELATED APPLICATIONS

This application is a continuation application of PCT Patent Application No. PCT/CN2022/105391, entitled “DATA PROCESSING METHOD AND APPARATUS, COMPUTER DEVICE, AND STORAGE MEDIUM” filed on Jul. 13, 2022, which claims priority to Chinese Patent Application No. 202110965200.0, entitled “DATA PROCESSING METHOD AND APPARATUS, COMPUTER DEVICE, AND STORAGE MEDIUM” filed with the China National Intellectual Property Administration on Aug. 23, 2021, all of which is incorporated herein by reference in its entirety.

### FIELD OF THE TECHNOLOGY

This application relates to the field of blockchain technologies, and in particular, to a data processing method and apparatus, a computer device, and a storage medium.

### BACKGROUND OF THE DISCLOSURE

A blockchain network corresponding to an existing blockchain node system may include a blockchain, and transactions corresponding to all transaction services generated by a service node in the blockchain network need to be recorded on the blockchain. When receiving the transactions sent by the service node, a consensus node in the blockchain network needs to store all the received transactions to a node transaction pool of the consensus node, such that all the transactions are queued in the node transaction pool to obtain a queuing result. Further, the consensus node may write each transaction to the blockchain according to the queuing result.

It may be understood that since all the transactions generated by the service node need to be written to the same blockchain, the blockchain may store transactions corresponding to different transaction services, and further, different transaction services on the blockchain cannot be effectively distinguished.

### SUMMARY

According to various embodiments provided in this application, a data processing method and apparatus, a computer device, and a storage medium are provided.

An aspect of the embodiments of this application provides a data processing method, performed by a target consensus node in a core consensus network and including:
receiving a transaction and a target chain identifier corresponding to the transaction, which are transmitted by a service node in a service network, the target chain identifier belonging to M chain identifiers configured by the core consensus network for the service node, the M chain identifiers belonging to chain identifiers of N service branch chains registered in the core consensus network, M being a positive integer less than or equal to N, one service branch chain corresponding to one transaction service, one service branch chain corresponding to one chain identifier, each of the N service branch chains being derived according to a derivation condition on a basic main chain in the core consensus network, and both the service network and the core consensus network being subnetworks in a blockchain network;
performing packing processing on the transaction based on a derivation condition corresponding to the target chain identifier to obtain a to-be-verified block for broadcasting to the core consensus network, and transmitting the to-be-verified block to at least a part of consensus nodes in the core consensus network except the target consensus node based on the target chain identifier, such that the consensus node performs block consensus on the to-be-verified block, the derivation condition corresponding to the target chain identifier being used for determining, in the basic main chain, a genesis block of a service branch chain corresponding to the target chain identifier; and receiving a first block consensus result returned by the consensus node for the to-be-verified block, and writing, based on the genesis block when the first block consensus result indicates that consensus succeeds, the to-be-verified block to the service branch chain corresponding to the target chain identifier.

An aspect of the embodiments of this application provides a computer device, including one or more processors and a memory.

The one or more processors are connected to the memory. The memory is configured to store computer-readable instructions. When the computer-readable instructions are executed by the one or more processors, the computer device is enabled to perform the method provided in the embodiments of this application.

An aspect of the embodiments of this application provides one or more non-transitory computer-readable storage media. The computer-readable storage medium stores computer-readable instructions. The computer-readable instructions are suitable for one or more processors to load and execute, such that a computer device with the processor performs the method provided in the embodiments of this application.

An aspect of the embodiments of this application provides a computer program product. The computer program product includes computer-readable instructions. The computer-readable instructions are stored in a computer-readable storage medium. One or more processors of a computer device read the computer-readable instructions from the computer-readable storage medium. The one or more processors execute the computer-readable instructions, such that the computer device performs the method provided in the embodiments of this application.

Details of one or more embodiments of this application will be provided in the following drawings and descriptions. Other features, objectives, and advantages of this application will become apparent in the specification, the drawings, and the claims.

### BRIEF DESCRIPTION OF THE DRAWINGS

In order to describe the technical solutions in the embodiments of this application more clearly, the drawings required to be used in descriptions about the embodiments will be simply described below. Apparently, the drawings in the descriptions below are merely some embodiments of this application. A person of ordinary skill in the art may further obtain other drawings according to these drawings without creative work.

FIG. 1A is a schematic diagram of a layered structure of a blockchain network according to an embodiment of this application.

FIG. 1B is a schematic diagram of a network architecture of a core consensus network according to an embodiment of this application.

FIG. 2 is a schematic diagram of a data interaction scenario according to an embodiment of this application.

FIG. 3 is a schematic flowchart of a data processing method according to an embodiment of this application.

FIG. 4 is a schematic diagram of a scenario in which a target consensus node obtains a transaction and a target chain identifier according to an embodiment of this application.

FIG. 5A is a schematic diagram of a scenario in which a to-be-verified block of a first block type is generated according to an embodiment of this application.

FIG. 5B is a schematic diagram of a scenario in which a to-be-verified block is written to a service branch chain corresponding to a target chain identifier according to an embodiment of this application.

FIG. 6 is a schematic flowchart of a data processing method according to an embodiment of this application.

FIG. 7 is a schematic diagram of a block synchronization scenario according to an embodiment of this application.

FIG. 8 is a diagram of a system architecture of a taxation blockchain system according to an embodiment of this application.

FIG. 9 is a schematic diagram of a structure of a data processing apparatus according to an embodiment of this application.

FIG. 10 is a schematic diagram of a computer device according to an embodiment of this application.

### DESCRIPTION OF EMBODIMENTS

The technical solutions in the embodiments of this application will be described clearly and completely below with reference to the drawings in the embodiments of this application. Clearly, the described embodiments are not all but only some embodiments of this application. All other embodiments obtained by a person of ordinary skill in the art based on the embodiments of this application without creative work shall fall within the protection scope of this application.

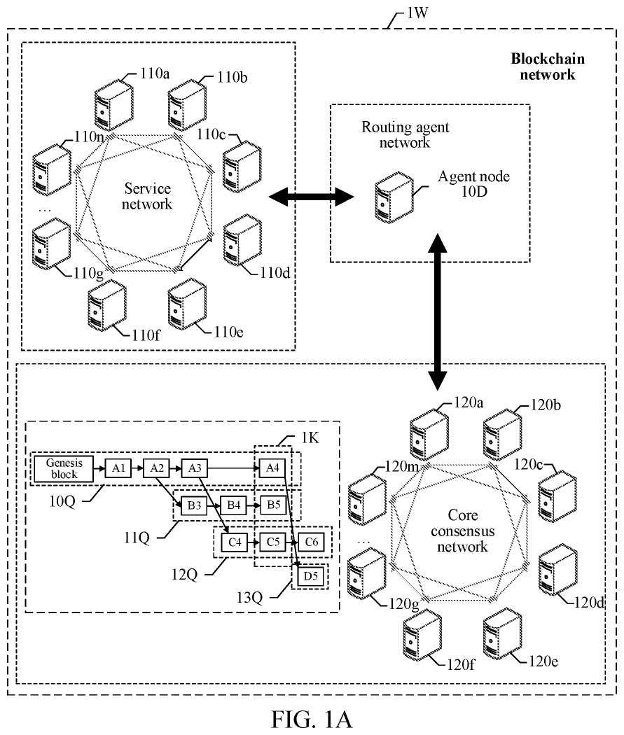

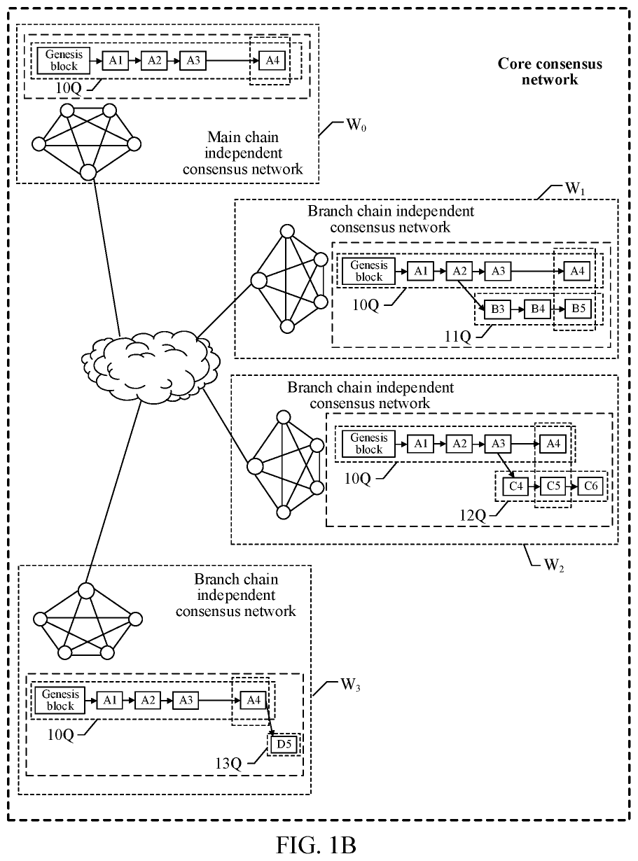

Refer to FIG. 1A. FIG. 1A is a schematic diagram of a layered structure of a blockchain network according to an embodiment of this application. In this embodiment of this application, the layered structure of the blockchain network may be a blockchain network 1W shown in FIG. 1A. A complete blockchain service system corresponding to the blockchain network 1W may include a service network, a core consensus network, and a routing agent network shown in FIG. 1A.

It is to be understood that a quantity of agent nodes in the routing agent network may be one or more, and this is not limited herein. In this embodiment of this application, an agent node 10D is used as an example. The agent node 10D may be configured to perform network isolation on the service network and the core consensus network. The agent node 10D may be an independent physical server, or a server cluster or distributed system including a plurality of physical servers, or a cloud server providing a basic cloud computing service. This is not limited herein. The agent node 10D may perform network layering on a peer to peer (P2P for short) network to form a layered structure of “service network-core consensus network”, thereby improving confidentiality and security of data on a blockchain.

A blockchain node system (that is, a first blockchain node system) corresponding to the service network (that is, a witness network) shown in FIG. 1A may include one or more blockchain nodes. A quantity of nodes in the first blockchain node system is not limited herein. For example, the first blockchain node system may specifically include a node 110a, a node 110b, a node 110c, . . . , and a node 110n. It is to be understood that, in this embodiment of this application, the blockchain node in the service network may be referred to as a service node, and the service node does not need to participate in accounting consensus, and is mainly configured to perform a transaction service to obtain a corresponding service transaction. The service node herein may be a full node including a complete blockchain database, or a lightweight node storing partial data in a blockchain database. This is not limited herein. In order to reduce a waste of storage space of the service node, the service node in this embodiment of this application may be, for example, a lightweight node (simplified payment verification (SPV)). The service node does not need to store complete transaction data, and instead, obtains, from the core consensus network shown in FIG. 1A through the agent node 10D, block header data and partial block data that the service node is authorized to access (for example, a service transaction associated with the service node).

A blockchain node system (that is, a second blockchain node system) corresponding to the core consensus network shown in FIG. 1A may include one or more blockchain nodes. A quantity of nodes in the second blockchain node system is not limited herein. For example, the second blockchain node system may specifically include a node 120a, a node 120b, a node 120c, . . . , and a node 120m. It is to be understood that, in this embodiment of this application, the node in the core consensus network is referred to as a consensus node (that is, an accounting node), and the consensus node may run a blockchain consensus protocol.

It is to be understood that, in this embodiment of this application, the agent node, the service node, and the consensus node may be collectively referred to as blockchain nodes in the blockchain network 1W. The blockchain node may be a server accessing the blockchain network 1W, or a user terminal accessing the blockchain network 1W. A specific form of the blockchain node is not limited herein. It may be understood that the service network and the core consensus network shown in FIG. 1A may be in different network environments. For example, in general, the service node is deployed in the service network in a public network, while the consensus node running the blockchain consensus protocol is deployed in the private core consensus network, and they may interact through a routing boundary.

For ease of understanding, in this embodiment of this application, one node (for example, the node 120a) may be selected from the core consensus network shown in FIG. 1A as a target consensus node in the core consensus network. When having a supervision permission, the target consensus node may be referred to as a consensus node with the supervision permission in the core consensus network. The consensus node with the supervision permission may be a consensus node corresponding to a main chain management object (that is, a main chain manager for managing a basic main chain 10Q in the core consensus network). A quantity of consensus nodes corresponding to the main chain manager is not limited herein. For example, if a blockchain node system corresponding to the blockchain network 1W shown in FIG. 1A is a taxation blockchain system applied to a taxation service, the node 120a with the supervision permission may be a terminal used by the State Administration of Taxation in the taxation blockchain system, and is configured to submit data information such as basic data and a service configuration to the basic main chain 10Q. The transaction service associated with the taxation blockchain system may be various taxation sub-services in the taxation service, specifically including a bill service, a credit information service, a blocking service, an enterprise qualification service, a tax refund service, and the like.

As shown in FIG. 1A, a blockchain in the core consensus network may include the basic main chain 10Q, service branch chains respectively corresponding to N transaction services derived from the basic main chain 10Q. Here, N is a positive integer. It is to be understood that the basic main chain 10Q in the core consensus network may include registration information of the service branch chain corresponding to each transaction service. The registration information of the service branch chain corresponding to each transaction service may include a chain identifier of the service branch chain, service configuration information of the transaction service, and a derivation condition corresponding to the chain identifier.

The service configuration information of the transaction service (for example, the bill service) herein may include basic information of the transaction service (that is, a description about the bill service) and node configuration information (including service node configuration information and consensus node configuration information). The service node configuration information may include a configured node identifier configured by the consensus node with the supervision permission (for example, the node 120a with the supervision permission) for the corresponding service branch chain (for example, a service branch chain corresponding to the bill service). A service node corresponding to the configured node identifier may be configured to perform the bill service. The consensus node configuration information herein may include an independent consensus node configured by the consensus node with the supervision permission for the service branch chain to participate in consensus of the service branch chain.

The derivation condition corresponding to each service branch chain herein may be used for determining, on the basic main chain 10Q, a genesis block of the corresponding service branch chain. Each service branch chain shown in FIG. 1A is obtained according to the derivation condition on the basic main chain 10Q. As shown in FIG. 1A, there may be, for example, three service branch chains in this embodiment of this application, specifically including a service branch chain 11Q, a service branch chain 12Q, and a service branch chain 13Q. One service branch chain corresponds to one transaction service. One service branch chain corresponds to one chain identifier. In this way, different transaction services can be effectively distinguished to ensure uniformity of data stored on a single service branch chain.

It is to be understood that if an information change occurs on configuration information of the blockchain node system (for example, the taxation blockchain system) corresponding to the entire blockchain network, another consensus node in the core consensus network needs to stop running. In this embodiment of this application, the configuration information on which the information change occurs may be referred to as configuration change information. For example, the configuration change information may be a change of a supervision rule and a calculation regulation in the field of taxation, a change of an important blockchain node, or alternation of a certificate authorizing node of a chain. The consensus node with the supervision permission in the core consensus network may generate a configuration change block based on the configuration change information, further upload the configuration change block to the basic main chain in the core consensus network, and synchronize the configuration change block to all the service branch chains. In this case, the other consensus node in the core consensus network may resume running. As shown in FIG. 1A, a block A4 in the basic main chain 10Q, a block B5 in the service branch chain 11Q, and a block C5 in the service branch chain 12Q in a region 1K in the core consensus network may be referred to as configuration change blocks.

The core consensus network shown in FIG. 1A may configure M chain identifiers for any service node in the service network. The M chain identifiers belong to chain identifiers of N service branch chains registered in the core consensus network. Here, M is a positive integer less than or equal to N. The consensus node with the supervision permission in the core consensus network may configure a same or different quantities of chain identifiers for the service nodes. This is not limited herein. For example, if a quantity of service branch chains derived from the basic main chain in the core consensus network is 3, and three chain identifiers are respectively a chain identifier 1s corresponding to a transaction service 1X (for example, the bill service), a chain identifier 2s corresponding to a transaction service 2X (for example, the credit information service), and a chain identifier 3s corresponding to a transaction service 3X (for example, the blocking service), when having the supervision permission, the node 120a in the core consensus network may dynamically configure two chain identifiers (for example, the chain identifier is and the chain identifier 3s) for the node 110a in the service network. When having the supervision permission, the node 120a may further dynamically configure three chain identifiers (for example, the chain identifier 1s, the chain identifier 2s, and the chain identifier 3s) for the node 110b in the service network, and so on. It may be understood that a plurality of chain identifiers may be dynamically configured for one service node to participate in performing transaction services corresponding to a plurality of service branch chains, thereby effectively ensuring lightweight of the service node and effective security control. In other words, the transaction services corresponding to the plurality of service branch chains may be performed with participation of the same service node, thereby effectively ensuring the lightweight of the service node and maintaining effective security control.

In the core consensus network, the target consensus node may further be configured to receive a service request transmitted by the service node in the service network. For example, the service request herein may include a transaction uploading request and a block synchronization request. The target consensus node may be a first consensus node with a first consensus permission. The first consensus permission herein is used for indicating that the first consensus node may participate in consensus of the basic main chain in the core consensus network and the N service branch chains derived from the basic main chain. Alternatively, the target consensus node may be a second consensus node with a second consensus permission. The second consensus permission herein is used for indicating that the second consensus node may participate in consensus of the basic main chain in the core consensus network and a service branch chain corresponding to a target chain identifier. That is, the second consensus node may be an independent consensus node configured to participate in consensus of the service branch chain corresponding to the target chain identifier.

For ease of understanding, further, Refer to FIG. 1B. FIG. 1B is a schematic diagram of a network architecture of a core consensus network according to an embodiment of this application. As shown in FIG. 1B, the core consensus network may be the core consensus network shown in FIG. 1A. When having a supervision permission, a target consensus node in the core consensus network may configure, for a specific service branch chain, consensus nodes for independent consensus of the service branch chain. The consensus nodes for the same service branch chain may form a branch chain independent consensus network. In addition, when having the supervision permission, the target consensus node in the core consensus network may configure consensus nodes for independent consensus of a basic main chain (for example, a basic main chain 10Q shown in FIG. 1B). The consensus nodes for independent consensus of the basic main chain may form a main chain independent consensus network. In this embodiment of this application, both the main chain independent consensus network and the branch chain independent consensus network may be referred to as independent consensus networks.

The core consensus network may include N branch chain independent consensus networks. A consensus node in each branch chain independent consensus network has a second consensus permission. That is, the consensus node in each branch chain independent consensus network may perform independent consensus on a same service branch chain, and synchronize data on the basic main chain 10Q. As shown in FIG. 1B, a quantity of branch chain independent consensus networks in the core consensus network in this embodiment of this application may be, for example, 3, and the three branch chain independent consensus networks may specifically include a branch chain independent consensus network W₁, a branch chain independent consensus network W₂, and a branch chain independent consensus network W₃.

A consensus node in the branch chain independent consensus network W₁ may be configured by a consensus node with the supervision permission (for example, the target consensus node) in the core consensus network for a service branch chain 11Q, and a blockchain in the branch chain independent consensus network W₁ may include the basic main chain (for example, the basic main chain 10Q shown in FIG. 1B) in the core consensus network and the service branch chain 11Q. This means that the consensus node in the branch chain independent consensus network W₁ needs to not only participate in consensus of the service branch chain 11Q but also synchronize data in the basic main chain 10Q in the core consensus network.

A consensus node in the branch chain independent consensus network W₂ may be configured by the consensus node with the supervision permission in the core consensus network for a service branch chain 12Q, and a blockchain in the branch chain independent consensus network W₂ may include the basic main chain 10Q in the core consensus network and the service branch chain 12Q. This means that the consensus node in the branch chain independent consensus network W₂ needs to not only participate in consensus of the service branch chain 12Q but also synchronize the data in the basic main chain 10Q in the core consensus network.

By analogy, a consensus node in the branch chain independent consensus network W₃ may be configured by the consensus node with the supervision permission in the core consensus network for a service branch chain 13Q, and a blockchain in the branch chain independent consensus network W₃ may include the basic main chain 10Q in the core consensus network and the service branch chain 13Q. This means that the consensus node in the branch chain independent consensus network W₃ needs to not only participate in consensus of the service branch chain 13Q but also synchronize the data in the basic main chain 10Q in the core consensus network.

The embodiments of this application may provide a data processing method of deriving a plurality of service branch chains from a basic main chain in a core consensus network. In this way, it can be effectively ensured that the basic main chain is a trust root of all the service branch chains. Global information such as a service configuration of each service branch chain is collected, so that convenience is brought to subsequent supervision and review. In addition, simultaneous running of the plurality of service branch chains can improve concurrency of different transaction services and reduce waiting time of the transaction services during uploading, thereby improving resource utilization and further improving system efficiency.

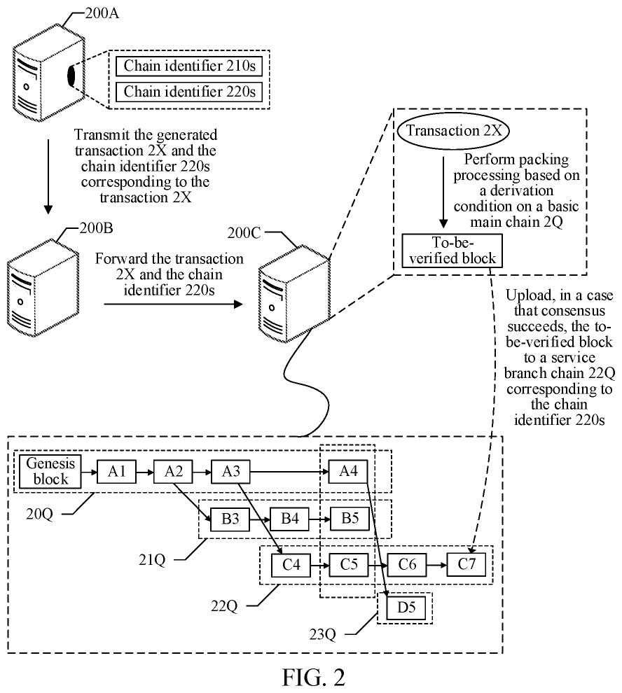

For ease of understanding, further, refer to FIG. 2. FIG. 2 is a schematic diagram of a data interaction scenario according to an embodiment of this application. As shown in FIG. 2, a service node 200A in this embodiment of this application may be any service node in a service network, for example, the node 110a in the service network shown in FIG. 1A. An agent node 200B in this embodiment of this application may be an agent node in a routing agent network, for example, the agent node 10D shown in FIG. 1A. A consensus node 200C in this embodiment of this application may be a target consensus node in a core consensus network. The target consensus node may be a first consensus node with a first consensus permission, for example, the node 120a in the core consensus network shown in FIG. 1A. The service network in which the service node 200A is, the routing agent network in which the agent node 200B is, and the core consensus network in which the consensus node 200C is are all subnetworks in a blockchain network.

Since the consensus node 200C has the first consensus permission, a blockchain run by the consensus node 200C may include a basic main chain (for example, a basic main chain 20Q) in the core consensus network and N service branch chains derived from the basic main chain 20Q. Here, N is a positive integer. As shown in FIG. 2, there may be, for example, three service branch chains in this embodiment of this application, specifically including a service branch chain 21Q, a service branch chain 22Q, and a service branch chain 23Q. One service branch chain corresponds to one transaction service. One service branch chain corresponds to one chain identifier. Each service branch chain shown in FIG. 2 is obtained by a consensus node with a supervision permission (that is, a consensus node corresponding to a main chain manager) based on a derivation condition on the basic main chain 20Q. The derivation condition corresponding to each service branch chain herein may be used for determining, on the basic main chain 20Q, a genesis block corresponding to the service branch chain. The consensus node with the supervision permission may be the consensus node 200C shown in FIG. 2, or another node in the core consensus network in which the consensus node 200C is. The consensus node with the supervision permission is not limited herein.

As shown in FIG. 2, a chain identifier (for example, a chain identifier 210s) of the service branch chain 21Q may be determined by the consensus node with the supervision permission when creating a specific transaction service (that is, a first transaction service, for example, a bill service) in a blockchain node system corresponding to the blockchain network. The service branch chain 21Q may be a service subchain derived by the consensus node with the supervision permission from a block A2 on the basic main chain 20Q based on a derivation condition corresponding to the chain identifier 210s on the basic main chain 20Q. The derivation condition corresponding to the chain identifier 210s may be used for determining, on the basic main chain 20Q, a genesis block (for example, the block A2) of the service branch chain 21Q. The service branch chain 21Q may further include a block B3, a block B4, and a block B5.

A chain identifier (for example, a chain identifier 220s) of the service branch chain 22Q may be determined by the consensus node with the supervision permission when creating another transaction service (that is, a second transaction service, for example, a credit information service) in the blockchain node system corresponding to the blockchain network. The service branch chain 22Q may be a service subchain derived by the consensus node with the supervision permission from a block A3 on the basic main chain 20Q based on a derivation condition corresponding to the chain identifier 220s on the basic main chain 20Q. The derivation condition corresponding to the chain identifier 220s may be used for determining, on the basic main chain 20Q, a genesis block (for example, the block A3) of the service branch chain 22Q. The service branch chain 22Q may further include a block C4, a block C5, a block C6, and a block C7. The block C7 may include a transaction (a transaction 2X shown in FIG. 2) transmitted by the service node 200A shown in FIG. 2.

Similarly, a chain identifier (for example, a chain identifier 230s) of the service branch chain 23Q may be determined by the consensus node with the supervision permission when creating another transaction service (that is, a third transaction service, for example, a tax refund service) in the blockchain node system corresponding to the blockchain network. The service branch chain 23Q is a service subchain derived by the consensus node with the supervision permission from a block A4 on the basic main chain 20Q based on a derivation condition corresponding to the chain identifier 230s on the basic main chain 20Q. The derivation condition corresponding to the chain identifier 230s may be used for determining, on the basic main chain 20Q, a genesis block (for example, the block A4) of the service branch chain 23Q. The service branch chain 23Q may further include a block D5.

It is to be understood that the consensus node with the supervision permission in the core consensus network may also dynamically configure M chain identifiers for the service node 200A shown in FIG. 2 based on the three chain identifiers registered on the basic main chain 20Q. Here, M may be a positive integer less than or equal to 3. As shown in FIG. 2, there may be, for example, two chain identifiers in this embodiment of this application, specifically including the chain identifier 210s and the chain identifier 220s. It may be understood that the service node 200A may generate a service transaction (for example, the transaction 2X shown in FIG. 2) corresponding to the second transaction service when performing the credit information service, that is, the second transaction service. In this case, in this embodiment of this application, the transaction 2X shown in FIG. 2 may be referred to as the transaction, and the chain identifier 220s may be determined as a chain identifier (that is, a target chain identifier) corresponding to the transaction 2X. Further, the service node 200A may transmit both the transaction 2X and the chain identifier 220s corresponding to the transaction 2X to the agent node 200B shown in FIG. 2.

It may be understood that when receiving the transaction 2X and the chain identifier 220s, the agent node 200B may perform permission verification on the service node 200A (for example, verify transaction signature information of the service node 200A for the transaction 2X, a transaction format of the transaction 2X, and whether the service node 200A is a node in an invalid node list stored in the agent node 200B), and when determining that the service node 200A is valid, may further forward both the transaction 2X and the chain identifier 220s to the core consensus network, such that the consensus node in the core consensus network writes the transaction 2X to the service branch chain (that is, the service branch chain 22Q) corresponding to the chain identifier 220s.

When the consensus node 200C in the core consensus network receives the transaction 2X and the chain identifier 220s, the consensus node 200C may obtain the derivation condition corresponding to the chain identifier 220s from the basic main chain 20Q based on the chain identifier 220s, and further perform packing processing on the transaction based on the derivation condition corresponding to the chain identifier 220s, to obtain a to-be-verified block for broadcasting to the core consensus network. Further, the consensus node 200C may transmit the to-be-verified block to the consensus node (for example, another consensus node capable of participating in consensus of the service branch chain 22Q in the core consensus network in which the consensus node 200C is) in the core consensus network based on the chain identifier 220s, such that the consensus node performs block consensus on the to-be-verified block.

It may be understood that the consensus node 200C may receive a block consensus result (that is, a first block consensus result) returned by the consensus node for the to-be-verified block, and further perform result analysis on the first block consensus result. If the first block consensus result indicates that consensus succeeds, the consensus node 200C may write the to-be-verified block to the service branch chain 22Q corresponding to the chain identifier 220s based on the genesis block (the block A3) of the service branch chain 22Q. In other words, the consensus node 200C determines the to-be-verified block a next block of the block C6 (for example, a block C7 shown in FIG. 2) in the service branch chain 22Q.

Thus, it can be seen that service branch chains respectively corresponding to a plurality of transaction services may be derived from the basic main chain 20Q in the core consensus network shown in FIG. 2, and one service branch chain corresponds to one chain identifier. In this way, different transaction services can be effectively distinguished to ensure uniformity of data stored on a single service branch chain. In addition, the plurality of service branch chains (for example, three service branch chains) shown in FIG. 2 may run simultaneously during transaction uploading. This can reduce uploading waiting time of the service transactions, thereby improving resource utilization and concurrency of different transaction services that run simultaneously and further improving system efficiency.

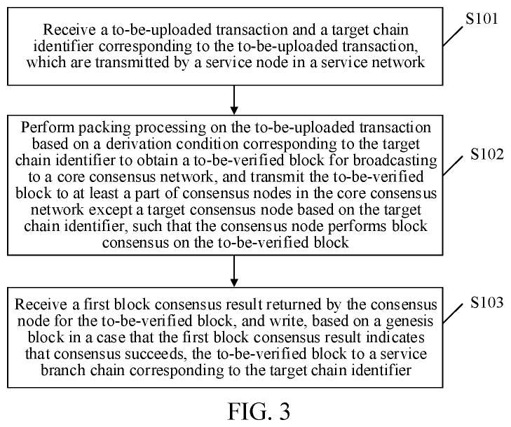

An embodiment of this application provides a bifurcated service tree-based blockchain structure in a blockchain node system. A plurality of service branch chains derived from a basic main chain may simultaneously run in a core consensus network of a blockchain network corresponding to the blockchain node system. A specific implementation in which a consensus node (for example, a target consensus node) in the core consensus network uploads, when receiving a transaction transmitted by a service node in a service network, the transaction to a corresponding service branch chain based on a target chain identifier corresponding to the transaction may refer to the following embodiments corresponding to FIG. 3 to FIG. 8.

Further, refer to FIG. 3. FIG. 3 is a schematic flowchart of a data processing method according to an embodiment of this application. As shown in FIG. 3, the method may be performed by a target consensus node (for example, a first consensus node with a first consensus permission) in a core consensus network. The target consensus node may be a service accessing the core consensus network, or a user terminal accessing the core consensus network. A specific form of the target consensus node is not limited herein. The target consensus node may be configured to participate in consensus of a basic main chain in the core consensus network and N (N is a positive integer) service branch chains derived from the basic main chain. For example, the target consensus node may be the node 120a in the core consensus network shown in FIG. 1A. The method may include at least the following step S101 to step S103:

Step S101: Receive a transaction and a target chain identifier corresponding to the transaction, which are transmitted by a service node in a service network.

Specifically, the target consensus node in the core consensus network may obtain a transaction uploading request forwarded by an agent node in a routing agent network. The routing agent network may be a subnetwork in a blockchain network in which the core consensus network is. The routing agent network is configured to perform network isolation on the service network and the core consensus network in the blockchain network. The transaction uploading request herein may be generated by the service node in the service network. The transaction uploading request may include the transaction, the target chain identifier corresponding to the transaction, transaction signature information corresponding to the transaction, and a node identifier of the service node. The transaction signature information may be obtained by the service node by signing the transaction based on a node private key of the service node. Further, the target consensus node may obtain a node public key of the service node, and further perform signature verification on the transaction signature information based on the node public key of the service node to obtain a signature verification result. It may be understood that when the signature verification result indicates that signature verification succeeds, the target consensus node may perform transaction verification on the transaction based on the target chain identifier and the node identifier of the service node to obtain a transaction verification result. If the transaction verification result indicates that transaction verification succeeds, the target consensus node may determine that the transaction uploading request is a valid request, and obtain the transaction and the target chain identifier from the transaction uploading request.

It is to be understood that when performing a target transaction service, the service node in the service network may generate a service transaction corresponding to the target transaction service, further determine the generated service transaction as the transaction, and determine a chain identifier corresponding to the target transaction service as the target chain identifier. The target transaction service herein is a transaction service corresponding to a specific chain identifier in M chain identifiers configured by the core consensus network for the service node. The M chain identifiers belong to chain identifiers of the N service branch chains registered in the core consensus network. Here, M is a positive integer less than or equal to N. It is to be understood that one service branch chain corresponds to one transaction service, and one service branch chain corresponds to one chain identifier. Each of the N service branch chains is obtained according to a derivation condition on a basic main chain in the core consensus network.

In order to effectively improve authenticity and security of the transaction during data transmission, the service node may perform signature processing on the transaction based on the node private key of the service node to obtain the transaction signature information corresponding to the transaction. Further, the service node may generate, based on the transaction, the target chain identifier corresponding to the transaction, the transaction signature information corresponding to the transaction, and the node identifier of the service node, a service request for uploading the transaction. In this embodiment of this application, the service request for uploading the transaction may be referred to as the transaction uploading request.

In this embodiment of this application, the blockchain network may include two subnetworks: the service network and the core consensus network. The service node in the service network may directly perform network interaction with the target consensus node in the core consensus network to implement data transmission between the two subnetworks. Based on this, when generating the transaction uploading request, the service node may directly transmit, based on the target chain identifier in the transaction uploading request, the transaction uploading request to the target consensus node capable of participating in consensus of a service branch chain corresponding to the target chain identifier in the core consensus network, such that the target consensus node successfully writes the transaction in the transaction uploading request to the service branch chain corresponding to the target chain identifier.

Alternatively, in this embodiment of this application, the blockchain network may include not only the service network and the core consensus network but also the routing agent network configured to perform network isolation on the service network and the core consensus network. The agent node in the routing agent network may realize a routing forwarding function between the service network and the core consensus network. Based on this, when generating the transaction uploading request, the service node (for example, the node 110a in the service network shown in FIG. 1A) needs to transmit the transaction uploading request to the agent node in the routing agent network, such that the agent node performs permission verification on the service node, and further broadcasts the transaction uploading request to the core consensus network when a permission verification result indicates that the service node is valid.

Permission verification herein may include verifying whether the node identifier of the service node is a node identifier in the invalid node list, verifying whether the transaction format of the transaction is wrong, verifying whether the transaction signature information of the transaction is wrong, and the like. The invalid node list herein may be a blacklist stored in the agent node. An invalid node corresponding to an invalid node identifier in the invalid node list may include a detected malicious node, a node reported by another person, a node transmitting transactions at an exceptional frequency in a specific time period, or the like.

When receiving the transaction uploading request forwarded by the agent node, the target consensus node in the core consensus network may obtain the node public key of the service node, and further perform signature verification on the transaction signature information in the transaction uploading request based on the node public key of the service node to obtain the signature verification result. When the signature verification result indicates that signature verification succeeds, the target consensus node may perform transaction verification on the transaction based on the target chain identifier and the node identifier of the service node, thereby obtaining the transaction verification result.

For example, when the signature verification result indicates that signature verification succeeds, the target consensus node may obtain registration information associated with the service branch chain corresponding to the target chain identifier from the basic main chain in the core consensus network, and further determine the obtained registration information as check registration information. Then, the target consensus node may obtain service node configuration information in the check registration information, and search in the service node configuration information for a configured node identifier matched with the node identifier of the service node. A service node corresponding to the configured node identifier is configured by the core consensus network (for example, a consensus node with a supervision permission in the core consensus network) for the service branch chain corresponding to the target chain identifier. The service node corresponding to the configured node identifier is configured to perform the target transaction service corresponding to the target chain identifier.

If the service node configuration information does not include the configured node identifier matched with the node identifier of the service node, the target consensus node may obtain a transaction verification result for indicating that transaction verification fails. Alternatively, if the service node configuration information includes the configured node identifier matched with the node identifier of the service node, the target consensus node may obtain a transaction verification result for indicating that transaction verification succeeds. It may be understood that if the transaction verification result indicates that transaction verification succeeds, the target consensus node may determine that the transaction uploading request is a valid request, and further obtain the transaction and the target chain identifier corresponding to the transaction from the transaction uploading request.

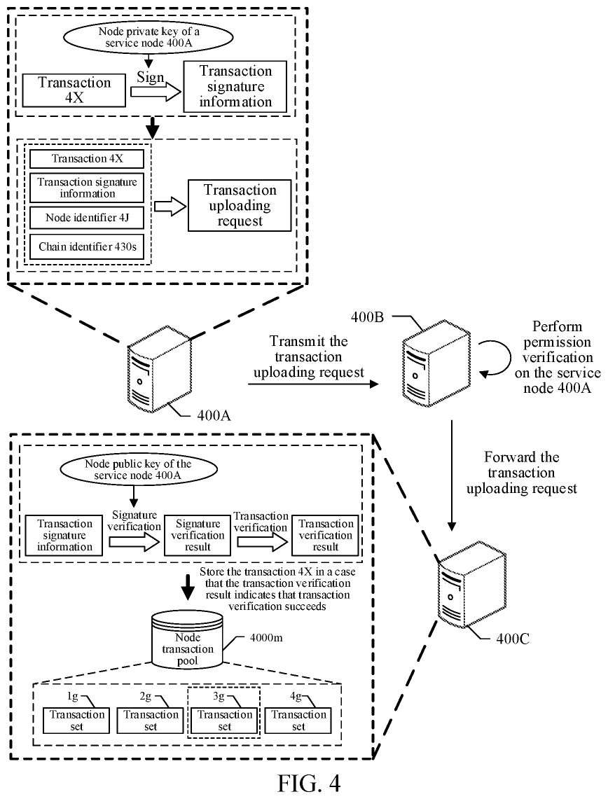

For ease of understanding, further, refer to FIG. 4. FIG. 4 is a schematic diagram of a scenario in which a target consensus node obtains a transaction and a target chain identifier according to an embodiment of this application. As shown in FIG. 4, a service node 400A in this embodiment of this application may be any service node configured to perform a target transaction service in a service network. For example, the service node 400A may be the service node 200A in the service network shown in FIG. 2. A consensus node 400C in this embodiment of this application may be the target consensus node in a core consensus network. The target consensus node may be a first consensus node with a first consensus permission. For example, the consensus node 400C may be the consensus node 200C shown in FIG. 2. An agent node 400B in this embodiment of this application may be configured to perform network isolation on the service network and the core consensus network. The agent node 400B may be the agent node 200B shown in FIG. 2.

A transaction 4X (that is, the transaction) shown in FIG. 4 is generated by the service node 400A when performing a transaction service (that is, the target transaction service, for example, a bill service) corresponding to a chain identifier 430s. The chain identifier 430s herein may be any one of M chain identifiers configured for the service node by the core consensus network in which the consensus node 400C is. Here, M is a positive integer less than N. Here, N may be a total quantity of service branch chains registered on a basic main chain in the core consensus network.

In order to effectively improve authenticity and security of the transaction 4X during data transmission, the service node 400A may perform signature processing on the transaction 4X based on a node private key of the service node 400A to obtain transaction signature information corresponding to the transaction 4X. It may be understood that the service node 400A may obtain a hash calculation rule for the transaction (that is, the transaction 4X). The hash calculation rule may be a digest algorithm predetermined by the service node 400A and another blockchain node (for example, the consensus node 400C) in a blockchain network. Therefore, the service node 400A may perform hash calculation on the transaction 4X based on the hash calculation rule to obtain digest information (for example, digest information h) of the transaction 4X. In this embodiment of this application, the digest information, determined by the service node 400A, of the transaction 4X may be referred to as first digest information. Further, the service node 400A may sign the first digest information based on the node private key of the service node 400A, thereby obtaining the transaction signature information shown in FIG. 4.

The service node 400A may generate, based on the transaction 4X, the chain identifier 430s corresponding to the transaction 4X, the transaction signature information corresponding to the transaction 4X, and a node identifier 4J of the service node 400A, a transaction uploading request for uploading the transaction 4X. Then, the service node 400A may transmit the transaction uploading request to the agent node 400B shown in FIG. 4, such that the agent node 400B performs permission verification on the service node 400A, and when a permission verification result indicates that the service node is valid, further broadcasts the transaction uploading request to the core consensus network.

The agent node 400B stores an invalid node list. An invalid node corresponding to an invalid node identifier in the invalid node list may include a detected malicious node, a node reported by another person, a node transmitting transactions at an exceptional frequency in a specific time period, or the like. For example, when receiving the transaction uploading request transmitted by the service node 400A, the agent node 400B may obtain the node identifier 4J of the service node 400A from the transaction uploading request, and further search in the invalid node list for the node identifier 4J of the service node 400A, thereby obtaining the permission verification result. If the permission verification result indicates that the invalid node list includes an invalid node identifier the same as the node identifier 4J of the service node 400A, the agent node 400B may determine that the permission verification result indicates that the service node is invalid. In this case, the agent node 400B may determine that the service node 400A is an invalid node, and does not need to broadcast the transaction uploading request to the core consensus network.

Alternatively, if the permission verification result indicates that the invalid node list does not include an invalid node identifier the same as the node identifier 4J of the service node 400A, the agent node 400B may determine that the permission verification result indicates that the service node is valid. In this case, the agent node 400B may determine that the service node 400A is a valid node, and further broadcast the transaction uploading request to a consensus node (for example, the consensus node 400C shown in FIG. 4) in the core consensus network based on the chain identifier 430s in the transaction uploading request.

The consensus node 400C may obtain a node public key of the service node 400A, and further perform signature verification on the transaction signature information in the transaction uploading request based on the node public key of the service node 400A to obtain a signature verification result. It may be understood that the consensus node 400C may obtain the node public key of the service node 400A, and further perform signature verification on the transaction signature information based on the node public key of the service node 400A to obtain the first digest information of the transaction 4X. Meanwhile, the consensus node 400C may further obtain the same hash calculation rule as the service node 400A, and perform hash calculation on the transaction 4X, thereby obtaining digest information (for example, digest information H) of the transaction 4X. In this embodiment of this application, the digest information, determined by the consensus node 400C, of the transaction 4X may be referred to as second digest information.

Then, the consensus node 400C may compare the first digest information with the second digest information to obtain the signature verification result, thereby determining whether the transaction 4X is tampered. It may be understood that if the first digest information is different from the second digest information, the consensus node 400C may determine that the signature verification result indicates that signature verification fails. Alternatively, if the first digest information is the same as the second digest information, the consensus node 400C may determine that the signature verification result indicates that signature verification succeeds, and this means that the transaction 4X is not tampered and is actually transmitted by the service node 400A.

Further, when the signature verification result indicates that signature verification succeeds, the consensus node 400C may perform transaction verification on the transaction 4X based on the target chain identifier 430s and the node identifier 4J of the service node 400A, thereby obtaining a transaction verification result. For example, when the signature verification result indicates that signature verification succeeds, the consensus node 400C may obtain registration information associated with a service branch chain corresponding to the chain identifier 430s from the basic main chain in the core consensus network, and further determine the obtained registration information as check registration information. Then, the consensus node 400C may obtain service node configuration information in the check registration information, and search in the service node configuration information for a configured node identifier matched with the node identifier 4J of the service node 400A. A service node corresponding to the configured node identifier may be configured by the core consensus network for the service branch chain corresponding to the chain identifier 430s. The service node corresponding to the configured node identifier may be configured to perform the target transaction service.

For ease of understanding, refer to Table 1. Table 1 is a configured node identifier list provided in this embodiment of this application. The configured node identifier list may be used for representing the service node configuration information obtained by the consensus node 400C from the basic main chain in the core consensus network. As shown in Table 1:

TABLE 1

| Configured | Configured | Configured |
|---|---|---|
| node name | node identifier | node address |
| Service node 100A | 117.114.151.174 | Address 1d |
| Service node 200A | 164.266.193.145 | Address 2d |
| Service node 300A | 123.396.527.111 | Address 3d |
| Service node 400A | 119.123.789.258 | Address 4d |

As shown in table 1, the configured node identifier list may include service nodes corresponding to a plurality of (for example, four) configured node identifiers, specifically including a service node 100A, a service node 200A, a service node 300A, and the service node 400A. The service node corresponding to each configured node identifier is configured by a consensus node with a supervision permission in the core consensus network for a specific service branch chain (for example, the service branch chain corresponding to the target chain identifier). This means that all the service nodes in Table 1 are qualified to perform the target transaction service corresponding to the target chain identifier. The node identifier in the configured node identifier list may be an Internet protocol (IP) address and any other information capable of identifying the node. Table 1 uses only the IP address as an example for description.

It may be understood that if the configured node identifier list (for example, the above Table 1) does not include the configured node identifier matched with the node identifier 4J (for example, 156.115.726.324) of the service node 400A, the consensus node 400C may obtain a transaction verification result for indicating that transaction verification fails. This means that the service node 400A is unqualified to perform the target transaction service corresponding to the chain identifier 430s. In this case, the consensus node 400C may determine that the transaction uploading request is an invalid request, and further generate an uploading failure notification for notifying the service node 400A for the agent node 400B to forward to the service node 400A. The uploading failure notification may be “You do not have the permission to perform this transaction service, so you cannot upload the transaction 4X. If necessary, you can go to the xx tax bureau to modify your permission”.

Alternatively, if the configured node identifier list includes the configured node identifier 4J matched with the node identifier 4J (for example, 119.123.789.258) of the service node 400A, the consensus node 400C may obtain a transaction verification result for indicating that transaction verification succeeds. This means that the service node 400A is qualified to perform the target transaction service corresponding to the chain identifier 430s. In this case, the consensus node 400C may determine that the transaction uploading request is a valid request, and further obtain the transaction 4X and the chain identifier 430s corresponding to the transaction 4X from the transaction uploading request.

Since the target consensus node in the core consensus network is the first consensus node with the first consensus permission, that is, the first consensus node may be configured to participate in consensus of the basic main chain in the core consensus network and the N service branch chains derived from the basic main chain, a node transaction pool of the first consensus node may include N transaction sets. One transaction set is used for storing a service transaction with a same chain identifier. If the transaction verification result indicates that transaction verification succeeds, the first consensus node may determine a transaction set corresponding to the target chain identifier from the N transaction sets, and store the transaction to the target transaction set corresponding to the target chain identifier.

As shown in FIG. 4, in this embodiment of this application, there may be, for example, four service branch chains derived from the basic main chain in which the consensus node 400C is. Therefore, a node transaction pool 4000m of the consensus node 400C may include four transaction sets. The four transaction sets may specifically include a transaction set 1g, a transaction set 2g, a transaction set 3g, and a transaction set 4g. The transaction set 1g is used for storing a service transaction associated with a chain identifier 410s. The transaction set 2g is used for storing a service transaction associated with a chain identifier 420s. The transaction set 3g is used for storing a service transaction associated with the chain identifier 430s. The transaction set 4g is used for storing a service transaction associated with a chain identifier 440s.

If the transaction verification result determined by the consensus node 400C indicates that transaction verification succeeds, the consensus node 400C may determine a transaction set (for example, the transaction set 3g shown in FIG. 4) corresponding to the chain identifier 430s from the four transaction sets, and further store the transaction 4X to the transaction set 3g.

Step S102: Perform packing processing on the transaction based on a derivation condition corresponding to the target chain identifier to obtain a to-be-verified block for broadcasting to the core consensus network, and transmit the to-be-verified block to at least a part of consensus nodes in the core consensus network except the target consensus node based on the target chain identifier, such that the consensus node performs block consensus on the to-be-verified block.

Specifically, the target consensus node may obtain a service transaction with a same chain identifier as the target chain identifier from a node transaction pool of the core consensus network, and further determine the obtained service transaction as a to-be-processed transaction. The to-be-processed transaction may include the transaction. Further, the target consensus node may perform packing processing on the to-be-processed transaction based on the derivation condition corresponding to the target chain identifier to obtain the to-be-verified block for broadcasting to the core consensus network. Then, the target consensus node may transmit the to-be-verified block to the consensus node in the core consensus network based on the target chain identifier. The consensus node receiving the to-be-verified block may be another consensus node with a consensus permission for the service branch chain corresponding to the target chain identifier in the core consensus network in which the target consensus node is.

As shown in FIG. 4, when performing packing processing on the transaction, that is, the transaction 4X, based on a derivation condition corresponding to the chain identifier 430s, the consensus node 400C may determine the transaction set 3g corresponding to the chain identifier 430s from the node transaction pool 4000m shown in FIG. 4, further obtain a service transaction including the transaction 4X from the transaction set 3g, and determine the obtained service transaction as a to-be-processed transaction.

It is to be understood that the target consensus node may determine the service branch chain corresponding to the target chain identifier as a target service branch chain, and further recognize a block type of the to-be-verified block to be generated on the target service branch chain. The block type of the to-be-verified block on the target service branch chain may include a first block type and a second block type. The first block type herein is used for indicating that a parent block of the to-be-verified block is a block on the basic main chain, that is, the to-be-verified block is a next block of a genesis block of the target service branch chain. This means that the target service branch chain derived from the current basic main chain includes only the genesis block (that is, a specific block, determined based on the derivation condition, on the basic main chain) of the target service branch chain, and the next block of the genesis block is yet not written after the genesis block. The second block type herein is used for indicating that a parent block of the to-be-verified block is not a block on the basic main chain, that is, the to-be-verified block is a next block of a non-genesis block of the target service branch chain. This means that the target service branch chain derived from the current basic main chain includes not only the genesis block of the target service branch chain but also another block that is written after and in a block index relationship with the genesis block.

Further, the target consensus node may determine the parent block of the to-be-verified block based on the block type and the derivation condition corresponding to the target chain identifier, and further determine a block hash value of the parent block of the to-be-verified block as a parent block hash value. It may be understood that if the block type is the first block type, the target consensus node may obtain target registration information associated with the target service branch chain from the basic main chain, and obtain the derivation condition corresponding to the target chain identifier from the target registration information. Further, the target consensus node may determine the genesis block of the target service branch chain based on the derivation condition corresponding to the target chain identifier, and further determine the determined genesis block as the parent block of the to-be-verified block. Then, the target consensus node may obtain the block hash value of the parent block of the to-be-verified block, and determine the obtained block hash value as the parent block hash value of the to-be-verified block.

Alternatively, if the block type is the second block type, the target consensus node may obtain a block with a maximum generation timestamp from the target service branch chain indicated by the derivation condition corresponding to the target chain identifier, and further determine the block with the maximum generation timestamp as the parent block of the to-be-verified block. Further, the target consensus node may obtain the block hash value of the parent block of the to-be-verified block, and determine the obtained block hash value as the parent block hash value of the to-be-verified block.

Then, the target consensus node may perform transaction hash transformation on the to-be-processed transaction to obtain a transaction hash value corresponding to the to-be-processed transaction, and determine a block hash value of the to-be-verified block based on the transaction hash value. Further, the target consensus node may perform packing processing on the to-be-processed transaction, the block hash value, and the parent block hash value to obtain the to-be-verified block to be written to the target service branch chain. A generation timestamp of the to-be-verified block is used for updating the maximum generation timestamp on the target service branch chain.

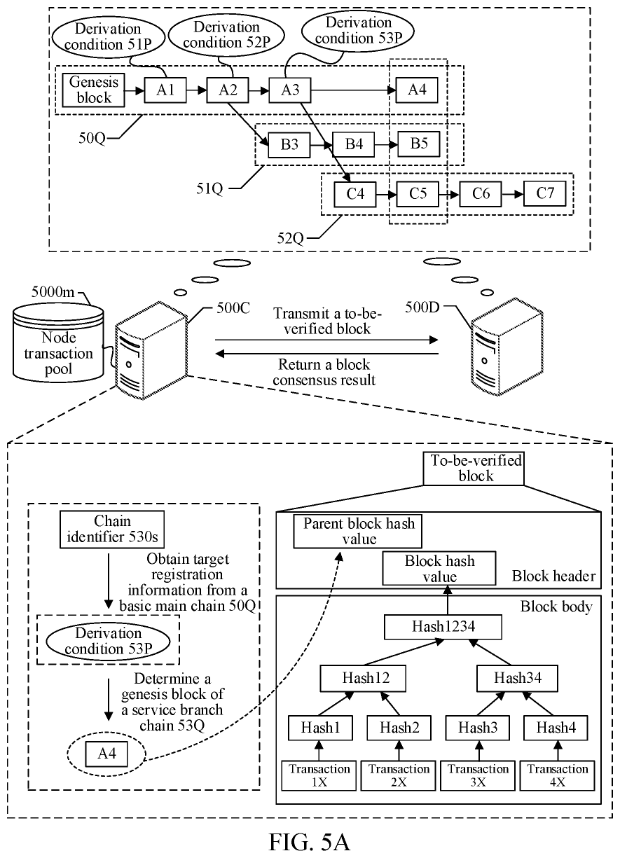

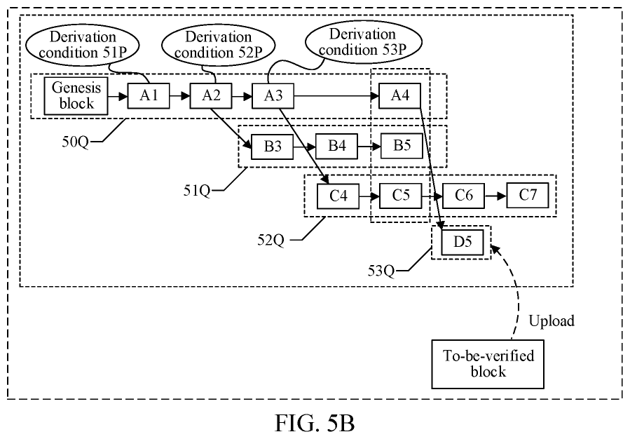

For ease of understanding, further, refer to FIG. 5A. FIG. 5A is a schematic diagram of a scenario in which a to-be-verified block of a first block type is generated according to an embodiment of this application. As shown in FIG. 5A, a consensus node 500C in this embodiment of this application may be a target consensus node in a core consensus network. The target consensus node may be a first consensus node with a first consensus permission. For example, the consensus node 500C may be the node 120a in the core consensus network shown in FIG. 1A. A consensus node 500D in this embodiment of this application may be another consensus node with the first consensus permission in the core consensus network. The consensus node 500D may be the node 120b in the core consensus network shown in FIG. 1A.

As shown in FIG. 5A, a blockchain in the core consensus network may include a basic main chain (for example, a basic main chain 50Q) and N service branch chains derived from the basic main chain 50Q. Here, there may be, for example, three service branch chains, specifically including a service branch chain 51Q, a service branch chain 52Q, and a service branch chain 53Q. One service branch chain corresponds to one transaction service. One service branch chain corresponds to one chain identifier. A chain identifier corresponding to the service branch chain 51Q may be a chain identifier 510s. A derivation condition (a derivation condition 51P in FIG. 5A) corresponding to the chain identifier 510s is used for determining, on the basic main chain 50Q, a genesis block (for example, a block A2) of the service branch chain 51Q. A chain identifier corresponding to the service branch chain 52Q may be a chain identifier 520s. A derivation condition (for example, a derivation condition 52P in FIG. 5A) corresponding to the chain identifier 520s is used for determining, on the basic main chain 50Q, a genesis block (for example, a block A3) of the service branch chain 52Q. A chain identifier corresponding to the service branch chain 53Q may be a chain identifier 530s. A derivation condition (for example, a derivation condition 53P in FIG. 5A) corresponding to the chain identifier 530s is used for determining, on the basic main chain 50Q, a genesis block (for example, a block A4) of the service branch chain 53Q. It may be understood that since a next block of the genesis block of the service branch chain 53Q is yet not written after the genesis block, there is not the service branch chain 53Q in FIG. 5A.

If a target chain identifier corresponding to a transaction (for example, a transaction 4X) received by the consensus node 500C is the chain identifier 530s, when performing packing processing on the transaction, the consensus node 500C may obtain a service transaction with a same chain identifier as the chain identifier 530s from a node transaction pool 5000m shown in FIG. 5A, and further determine the obtained service transaction as a to-be-processed transaction. The to-be-processed transaction may include a transaction 1X, a transaction 2X, a transaction 3X, and a transaction 4X shown in FIG. 5A.

Further, the consensus node 500C may recognize a block type of a to-be-verified block to be generated on the service branch chain 53Q (that is, a target service branch chain). Since the next block of the genesis block of the service branch chain 53Q is yet not written after the genesis block, the consensus node 500C may determine that the block type of the to-be-verified block is a first block type. In this case, the consensus node 500C may obtain registration information (that is, target registration information, for example, registration information stored in the block A3 shown in FIG. 5A) associated with the service branch chain 53Q from the basic main chain 50Q, and further obtain the derivation condition (for example, the derivation condition 53P shown in FIG. 5A) corresponding to the chain identifier 530s from the target registration information.

For example, the derivation condition 53P may be determining a next block of a block in which the derivation condition 53P is as the genesis block of the service branch chain 53Q. Alternatively, the derivation condition 53P may be determining a block in which the target registration information associated with the service branch chain 53Q is as the genesis block of the service branch chain 53Q. Alternatively, the derivation condition 53P may be determining a block with a maximum generation timestamp on the basic main chain 53Q as the genesis block of the service branch chain 53Q when a service transaction with the chain identifier 530s needs to be uploaded. A specific manner of the derivation condition is not limited herein.

It may be understood that the genesis block of the service branch chain 53Q determined by the consensus node 500C based on the derivation condition 53P may be the block A4 on the basic main chain 50Q shown in FIG. 5A. In this case, the consensus node may determine the block A4 as a parent block of the to-be-verified block to be generated, and further obtain a block hash value of the block A4 as a parent block hash value of the to-be-verified block.

Meanwhile, the consensus node 500C may perform transaction hash transformation on the four to-be-processed transactions, that is, the transaction 1X, the transaction 2X, the transaction 3X, and the transaction 4X, to obtain transaction hash values corresponding to the to-be-processed transactions, and further determine a block hash value of the to-be-verified block based on the transaction hash values. Further, the consensus node 500C may perform packing processing on the to-be-processed transaction, the block hash value, and the parent block hash value, thereby obtaining the to-be-verified block to be written to the service branch chain 53Q. A generation timestamp of the to-be-verified block is used for updating a maximum generation timestamp on a target service branch chain. It may be understood that the to-be-verified block may be determined as a next block of the block A4 (for example, a block D5) when written to the service branch chain 53Q.

Alternatively, as shown in FIG. 2, if a target chain identifier corresponding to a transaction (for example, a transaction 2X) received by a consensus node 200C is a chain identifier 220s, when performing packing processing on the transaction, the consensus node 200C may obtain a service transaction with a same chain identifier as the chain identifier 220s from a node transaction pool of the consensus node 200C, and further determine the obtained service transaction as a to-be-processed transaction.

Further, the consensus node 200C may recognize a block type of a to-be-verified block to be generated on a target service branch chain (for example, a service branch chain 22Q) corresponding to the chain identifier 220s. The service branch chain 22Q includes not only a genesis block (for example, a block A3 on the basic main chain 20Q) of the service branch chain 22Q but also another block (for example, a block C4, a block C5, and a block C6) that is written after and in a block index relationship with the genesis block. Therefore, the consensus node 200C may determine that the block type of the to-be-verified block shown in FIG. 2 is a second block type.

In this case, the consensus node 200C may obtain a block with a maximum generation timestamp from the service branch chain 22Q indicated by the derivation condition corresponding to the chain identifier 220s, and further determine the block with the maximum generation timestamp as a parent block (for example, the block C6) of the to-be-verified block. Further, the consensus node 200C may determine a block hash value of the block C6 as a parent block hash value of the to-be-verified block.

Meanwhile, the consensus node 200C may perform transaction hash transformation on the to-be-processed transaction, that is, the transaction 2X shown in FIG. 2, to obtain a transaction hash value corresponding to the to-be-processed transaction, and further determine a block hash value of the to-be-verified block based on the transaction hash value. Further, the consensus node 200C may perform packing processing on the to-be-processed transaction, the block hash value, and the parent block hash value, thereby obtaining the to-be-verified block to be written to the service branch chain 22Q. A generation timestamp of the to-be-verified block is used for updating a maximum generation timestamp on a target service branch chain. It may be understood that the to-be-verified block may be determined as a next block of the block C6 (for example, a block C7) on the service branch chain 22Q when written to the service branch chain 22Q.

Further, after generating the to-be-verified block, the target consensus node may transmit the to-be-verified block to the consensus node in the core consensus network based on the target chain identifier. The consensus node herein may be configured to participate in consensus of the service branch chain (that is, the target service branch chain) corresponding to the target chain identifier. As shown in FIG. 5A, after generating the to-be-verified block, the consensus node 500C may transmit the to-be-verified block to the consensus node 500D shown in FIG. 5A based on the chain identifier 530s, such that the consensus node 500D performs consensus on the to-be-verified block to obtain a block consensus result (that is, a first block consensus result).

Step S103: Receive a first block consensus result returned by the consensus node for the to-be-verified block, and write, based on the derivation condition when the first block consensus result indicates that consensus succeeds, the to-be-verified block to the service branch chain corresponding to the target chain identifier.

Specifically, the target consensus node may receive a first block consensus result returned by another consensus node in the core consensus network for the to-be-verified block, and further perform result analysis on the first block consensus result. If consensus results of a quantity exceeding a consensus threshold (for example, ½ or ⅔) in the first block consensus result indicate that consensus succeeds, the target consensus node may determine that the consensus nodes in the core consensus network reach a consensus, and further write, based on the derivation condition, the to-be-verified block to the service branch chain corresponding to the target chain identifier.

Further, refer to FIG. 5B. FIG. 5B is a schematic diagram of a scenario in which the to-be-verified block is written to the service branch chain corresponding to the target chain identifier according to an embodiment of this application. As shown in FIG. 5B, a basic main chain in a core consensus network and service branch chains derived from the basic main chain in this embodiment of this application may refer to the basic main chain and the service branch chains shown in FIG. 5A. An uploading process described in FIG. 5B may be a process in which the consensus node 500C in FIG. 5A performs block uploading after receiving the block consensus result of the consensus node 500D for the to-be-verified block.

It is to be understood that the consensus node 500C may perform result analysis on the block consensus result after receiving the block consensus result (that is, the first block consensus result) returned by the consensus node 500D for the to-be-verified block. If consensus results of a quantity exceeding a consensus threshold (for example, ½ or ⅔) in the first block consensus result indicate that consensus succeeds, the consensus node 500C may determine that consensus nodes in the core consensus network reach a consensus, and further write, based on the derivation condition 53P, the to-be-verified block to the service branch chain 53Q corresponding to the chain identifier 530s, that is, determine the to-be-verified block as the next block, that is, the block D5, of the block A4 in the basic main chain 50Q.

In this embodiment of this application, all the M chain identifiers configured by the core consensus network for the service node in the service network belong to chain identifiers of the N service branch chains registered in the core consensus network. M is a positive integer less than or equal to N. This means that a service node may be qualified to perform M transaction services, but cannot perform a transaction service corresponding to another chain identifier not configured for the service node. This can not only ensure lightweight of the service node but only implement effective security control on the service node. It may be understood that each of the N service branch chains is obtained according to the derivation condition on the basic main chain in the core consensus network. This means that in this embodiment of this application, the basic main chain may be determined as a trust root of all transaction services. Global information (that is, registration information respectively corresponding to all the service branch chains) such as subchain configurations respectively corresponding to all the service branch chains is collected, thereby bringing convenience to supervision and review and further effectively solving the problem of inconsistency of each service branch chain caused by non-uniformity of data. In addition, in the core consensus network, one service branch chain corresponds to one transaction service, and one service branch chain corresponds to one chain identifier, instead of storing all transactions generated for the N transaction services on a single blockchain indistinguishably. In this way, different transaction services can be effectively distinguished to ensure uniformity of transaction storage on each service branch chain. It may be understood that running processes of the N service branch chains in the core consensus network may all refer to a process in which the target consensus node runs the service branch chain corresponding to the target chain identifier. In this way, when the N service branch chains run simultaneously, concurrency of different transaction services can be improved, and uploading waiting time of the transaction services can further be reduced, thereby improving resource utilization and further improving system efficiency.

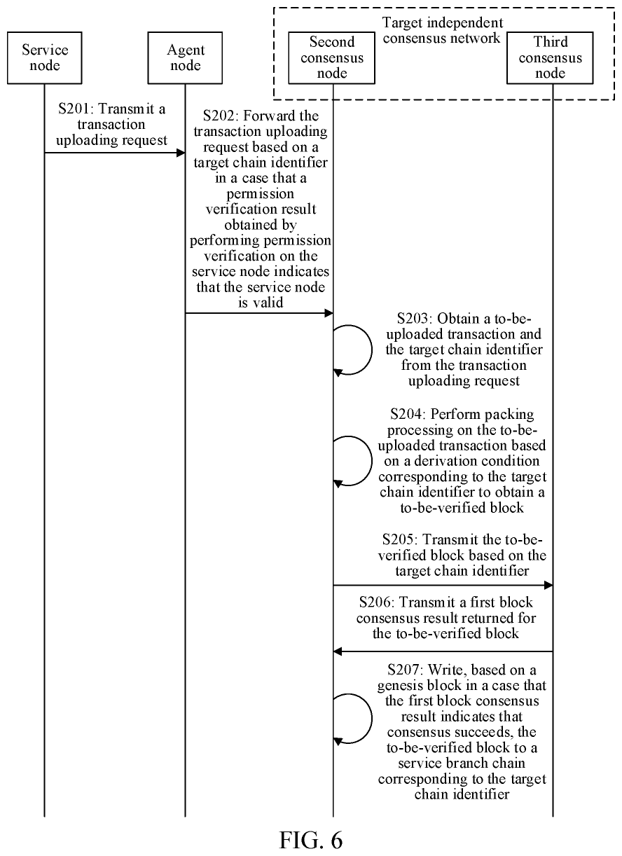

Further, refer to FIG. 6. FIG. 6 is a schematic flowchart of a data processing method according to an embodiment of this application. As shown in FIG. 6, the method may be performed by a service node in a service network, an agent node in a routing agent network, a target consensus node (for example, a second consensus node with a second consensus permission) in a target independent consensus network, and another consensus node (for example, a third consensus node configured to perform block consensus on a to-be-verified block) in the target independent consensus network. The service node may be configured to perform a transaction service (that is, a target transaction service) corresponding to a target chain identifier in configured M chain identifiers. The service node may be any service node, for example, the node 110a, in the service network shown in FIG. 1A. The agent node may be configured to perform network isolation on the service network and a core consensus network. For example, the agent node may be the agent node 10D shown in FIG. 1A. Both the second consensus node and the third consensus node may be configured to participate in consensus of a service branch chain corresponding to the target chain identifier. For example, the target independent consensus network to which the second consensus node and the third consensus node belong may be any branch chain independent consensus network, for example, the branch chain independent consensus network W₁, in the core consensus network shown in FIG. 1B. The method may include at least the following step S201 to step S207:

Step S201: The service node in the service network transmits a generated transaction uploading request to the agent node in the routing agent network.

Specifically, when performing the target transaction service, the service node in the service network may generate a service transaction corresponding to the target transaction service, further determine the generated service transaction as a transaction, and determine a chain identifier corresponding to the target transaction service as the target chain identifier. The target transaction service herein is a transaction service corresponding to a specific chain identifier in the M chain identifiers configured by the core consensus network for the service node. The M chain identifiers belong to chain identifiers of N service branch chains registered in the core consensus network. Here, M is a positive integer less than or equal to N. It is to be understood that one service branch chain corresponds to one transaction service, and one service branch chain corresponds to one chain identifier. Each of the N service branch chains is obtained according to a derivation condition on a basic main chain in the core consensus network. Further, the service node may perform signature processing on the transaction based on a node private key of the service node to obtain transaction signature information corresponding to the transaction. Further, the service node may generate, based on the transaction, the target chain identifier corresponding to the transaction, the transaction signature information corresponding to the transaction, and a node identifier of the service node, the transaction uploading request for uploading the transaction, and further transmit the transaction uploading request to the agent node in the routing agent network.

Step S202: The agent node performs permission verification on the service node, and forwards the transaction uploading request to the second consensus node in the corresponding target independent consensus network based on the target chain identifier in the transaction uploading request when a permission verification result indicates that the service node is valid.

The agent node may be configured to record independent consensus node information of an independent consensus node in the core consensus network, and further realize a routing forwarding function between the service network and the core consensus network based on the recorded independent consensus node information. Specifically, when receiving the transaction uploading request, the agent node may perform permission verification on the service node (for example, verify whether the node identifier of the service node is a node identifier in an invalid node list, verify whether a transaction format of the transaction is wrong, or verify whether the transaction signature information of the transaction is wrong) to obtain the permission verification result. When the permission verification result indicates that the service node is valid, the agent node may determine the target independent consensus network corresponding to the target chain identifier from N branch chain independent consensus networks in the core consensus network based on the target chain identifier and the independent consensus node information, and further transmit the transaction uploading request to the second consensus node in the target independent consensus network.

For ease of understanding, further, refer to Table 2. Table 2 is an independent consensus node information table provided in this embodiment of this application. The independent consensus node information table may be used for representing the independent consensus node information recorded by the agent node based on the basic main chain (for example, the basic main chain 10Q shown in FIG. 1B). As shown in Table 2:

TABLE 2

| Chain identifier | Independent consensus network | Consensus node |
|---|---|---|
| Chain identifier 0s | Main chain independent consensus | Node 120a |
| | network W₀ | . . . |
| | | Node 120c |
| Chain identifier 1s | Branch chain independent | Node 120d |
| | consensus network W₁ | . . . |
| | | Node 120f |
| Chain identifier 2s | Branch chain independent | Node 120g |
| | consensus network W₂ | . . . |
| | | Node 120i |
| Chain identifier 3s | Branch chain independent | Node 120j |
| | consensus network W₃ | . . . |
| | | Node 120m |

It is to be understood that the basic main chain in the core consensus network may include registration information of a service branch chain corresponding to each transaction service. The registration information of the service branch chain corresponding to each transaction service may include a chain identifier of the service branch chain, service configuration information (including consensus node configuration information) of the transaction service, and a derivation condition corresponding to the chain identifier. The consensus node configuration information may be an independent consensus node configured by a consensus node with a supervision permission in the core consensus network for the service branch chain to participate in consensus of the service branch chain. Therefore, the agent node may obtain the registration information of each service branch chain from the basic main chain in the core consensus network, and further determine a mapping relationship between the chain identifier of each service branch chain, the consensus node configuration information, and a branch chain independent consensus network formed by the consensus node configuration information based on the obtained registration information, to generate the independent consensus node information shown in Table 2. In addition, after the core consensus network creates a new transaction service, the agent node may obtain new registration information associated with the new transaction service, and further dynamically update Table 2 based on the new registration information.

It may be understood that when the permission verification result indicates that the service node is valid, the agent node may determine the target independent consensus network (for example, the branch chain independent consensus network W₁) corresponding to the target chain identifier from the N branch chain independent consensus networks in the core consensus network based on the target chain identifier (for example, a chain identifier 2s) and the independent consensus node information shown in Table 2, and further transmit the transaction uploading request to the second consensus node (for example, a node 120d) in the target independent consensus network.

Step S203: The second consensus node obtains the transaction and the target chain identifier corresponding to the transaction from the transaction uploading request.

The transaction uploading request herein may include the transaction, the target chain identifier corresponding to the transaction, the transaction signature information corresponding to the transaction, and the node identifier of the service node. The transaction signature information may be obtained by the service node by signing the transaction based on the node private key of the service node. Further, the second consensus node may obtain a node public key of the service node, and further perform signature verification on the transaction signature information based on the node public key of the service node to obtain a signature verification result. It may be understood that when the signature verification result indicates that signature verification succeeds, the second consensus node may perform transaction verification on the transaction based on the target chain identifier and the node identifier of the service node to obtain a transaction verification result. If the transaction verification result indicates that transaction verification succeeds, the second consensus node may determine that the transaction uploading request is a valid request, and obtain the transaction and the target chain identifier from the transaction uploading request.

Step S204: The second consensus node performs packing processing on the transaction based on a derivation condition corresponding to the target chain identifier to obtain a to-be-verified block for broadcasting to the core consensus network.

Specifically, the second consensus node may directly obtain a service transaction with a same chain identifier as the target chain identifier from a node transaction pool of the second consensus node, and further determine the obtained service transaction as a to-be-processed transaction. Since the second consensus node is an independent consensus node, the node transaction pool of the second consensus node may store the service transaction with the same chain identifier as the target chain identifier, and does not need to store a service transaction with another chain identifier. The to-be-processed transaction may include the transaction. Further, the second consensus node may perform packing processing on the to-be-processed transaction based on the derivation condition corresponding to the target chain identifier to obtain the to-be-verified block for broadcasting to the target independent consensus network.

Step S205: The second consensus node transmits the to-be-verified block to the third consensus node in the target independent consensus node based on the target chain identifier, such that the third consensus node in the target independent consensus network performs block consensus on the to-be-verified block.

The third consensus node receiving the to-be-verified block may be any consensus node in a branch chain independent consensus network in which a first consensus node is, for example, a node 120f in the branch chain independent consensus network W₁ shown in Table 2.

Step S206: The second consensus node receives a first block consensus result returned by the third consensus node for the to-be-verified block.

Specifically, the second consensus node may receive the first block consensus result returned by the third consensus node for the to-be-verified block, and further perform result analysis on the first block consensus result.

Step S207: The second consensus node writes, based on a genesis block when the first block consensus result indicates that consensus succeeds, the to-be-verified block to the service branch chain corresponding to the target chain identifier.

Specifically, if consensus results of a quantity exceeding a consensus threshold (for example, ½ or ⅔) in the first block consensus result indicate that consensus succeeds, the second consensus node may determine that consensus nodes in the core consensus network reach a consensus, and further write, based on the derivation condition, the to-be-verified block to the service branch chain corresponding to the target chain identifier.

Specific implementations of step S201 to step S207 may refer to the descriptions about step S101 to step S103 in the embodiment corresponding to FIG. 3, and will not be elaborated herein.

It is to be understood that in the embodiments of this application, when the target consensus node (for example, the first consensus node with the first consensus permission or the second consensus node with the second consensus permission) in the core consensus network successfully writes the to-be-verified block to the service branch chain corresponding to the target chain identifier, the target consensus node may obtain the target registration information associated with the service branch chain corresponding to the target chain identifier from the basic main chain, and obtain the service node configuration information corresponding to the target chain identifier from the target registration information. Further, the target consensus node may transmit the service node configuration information and a target block height of the to-be-verified block to the agent node in the routing agent network, such that the agent node forwards the target block height to the service node (that is, a target service node) corresponding to the configured node identifier in the service node configuration information. The target block height may be used for instructing the target service node to generate a block synchronization request based on an initial block height on a local blockchain and a chain identifier corresponding to the initial block height.

In this case, when receiving the target block height forwarded by the agent node, the target service node may determine the initial block height on the local blockchain, generate the block synchronization request based on the initial block height and the chain identifier corresponding to the initial block height, and further transmit the block synchronization request to the agent node, such that the agent node forwards the block synchronization request to the target consensus node in the core consensus network. Further, when receiving the block synchronization request, the target consensus node may determine, based on the initial block height and the chain identifier corresponding to the initial block height in the block synchronization request, a to-be-synchronized block for synchronization to the target service node. Further, the target consensus node may transmit the to-be-synchronized block to the target service node through the agent node, such that the target service node writes the to-be-synchronized block to a corresponding service branch chain in the local blockchain when the to-be-synchronized block is successfully verified.

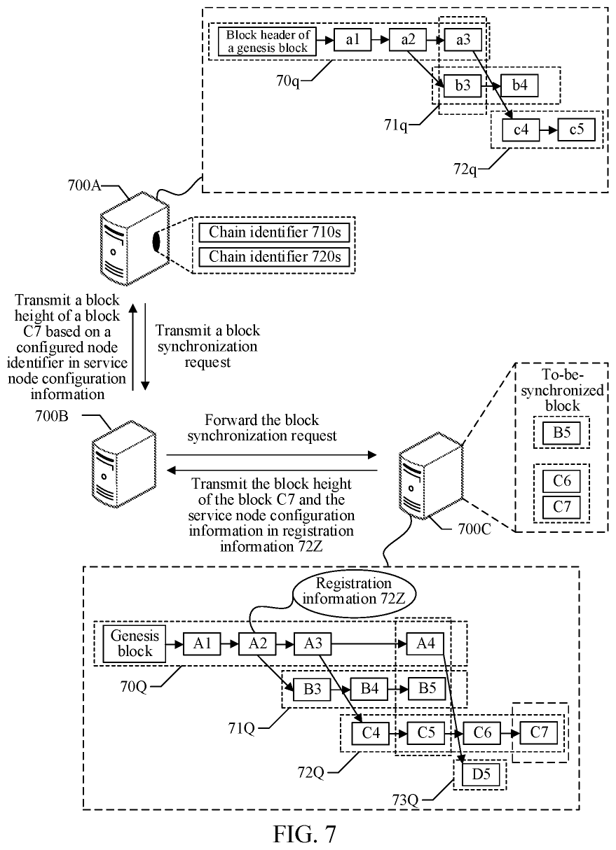

For ease of understanding, further, refer to FIG. 7. FIG. 7 is a schematic diagram of a block synchronization scenario according to an embodiment of this application. As shown in FIG. 7, a service node 700A in this embodiment of this application may be a target service node in a service network. The target service node may be configured by a core consensus network for a service branch chain corresponding to a target chain identifier. For example, the service node 700A may be the service node 200A in the service network shown in FIG. 2. A consensus node 700C in this embodiment of this application may be a target consensus node in the core consensus network. The target consensus node may be a first consensus node with a first consensus permission. For example, the consensus node 700C may be the consensus node 200C shown in FIG. 2. An agent node 700B in this embodiment of this application may be configured to perform network isolation on the service network and the core consensus network. The agent node 700B may be the agent node 200B shown in FIG. 2.

As shown in FIG. 7, a local blockchain of the service node 700A may include partial block data of service branch chains respectively corresponding to M (for example, two) chain identifiers configured by the core consensus network for the target service node, specifically including partial block data (for example, a service branch chain 71q) of a service branch chain 71Q corresponding to a chain identifier 710s and partial block data (for example, a service branch chain 72q) of a service branch chain 72Q corresponding to a chain identifier 720s. In addition, the local blockchain of the service node 700A may further include partial block data (for example, a basic main chain 70q) on a basic main chain 70Q. All of the basic main chain 70q, the service branch chain 71q, and the service branch chain 72q may be referred to as block header chains. The block header chain may be a chain structure including a plurality of block headers connected end to end. For example, the basic main chain 70q may include a block header of a genesis block, a block header a1, a block header a2, and a block header a3. The service branch chain 71q may include a block header b3 and a block header b4. The service branch chain 72q may include a block header c4 and a block header c5. The block header a1 may be block header data of a block A1 of the basic main chain 70Q in the core consensus network.

When successfully writing a to-be-verified block (for example, a block C7) to the service branch chain 72Q corresponding to the target chain identifier (that is, the chain identifier 720s), the consensus node 700C may obtain target registration information (for example, registration information 72Z shown in FIG. 7) associated with the service branch chain 72Q from the basic main chain 70Q, and further obtain service node configuration information corresponding to the chain identifier 720s from the registration information 72Z. A configured node identifier in the service node configuration information may include a node identifier of the service node 700A shown in FIG. 7. In this case, the consensus node 700C may transmit a block height (that is, a target block height) of the block C7 and the service node configuration information together to the agent node 700B.

The agent node 700B may transmit the block height of the block C7 to a service node (for example, the service node 700A) corresponding to the configured node identifier based on the configured node identifier in the service node configuration information. In order to improve data transmission security, the agent node 700B may further obtain a system public key of the service network, perform encryption processing on the block height of the block C7 to obtain system encrypted data information, and further forward the system encrypted data information to the service node 700A. When receiving the system encrypted data information, the service node 700A may perform decryption processing on the system encrypted data information based on a system private key corresponding to the system public key to obtain the block height of the block C7.

Further, the service node 700A may obtain an initial block height (that is, a maximum block height) of each service branch chain on the local blockchain, and further generate, based on the initial block height of each service branch chain and a chain identifier corresponding to the initial block height, a block synchronization request for transmission to the agent node 700B.

For example, a maximum block height obtained by the service node 700A on the service branch chain 71q is a block height of the block header b4, and the block height of the block header b4 may further be referred to as an initial block height on the service branch chain 71q. For another example, a maximum block height obtained by the service node 700A on the service branch chain 72q is a block height of the block header c5, and the block height of the block header c5 may further be referred to as an initial block height on the service branch chain 72q. In this case, the service node 700A may generate, based on the initial block height on the service branch chain 71q, the chain identifier 710s corresponding to the initial block height on the service branch chain 71q, the initial block height on the service branch chain 72q, and the chain identifier 720s corresponding to the initial block height on the service branch chain 72q, the block synchronization request for transmission to the agent node 700B, such that the agent node 700B may forward the block synchronization request to the consensus node 700C.

Further, the consensus node 700C may determine, based on the initial block height and the chain identifier corresponding to the initial block height in the block synchronization request, a to-be-synchronized block for synchronization to the service node corresponding to the configured node identifier. For example, the consensus node 700C may determine a maximum block height on the service branch chain 71Q based on the chain identifier 710s corresponding to the initial block height on the service branch chain 71q, and further determine, based on the initial block height on the service branch chain 71q and the maximum block height on the service branch chain 71Q, a to-be-synchronized block (for example, a block B5) for synchronization to the service branch chain 71q. Meanwhile, the consensus node 700C may determine a maximum block height on the service branch chain 72Q based on the chain identifier 720s corresponding to the initial block height on the service branch chain 72q, and further determine, based on the initial block height on the service branch chain 72q and the maximum block height on the service branch chain 72Q, a to-be-synchronized block (for example, a block C6 and a block C7) for synchronization to the service branch chain 72q.

Further, the consensus node 700C may transmit the to-be-synchronized block (that is, the block B5, the block C6, and the block C7) on each service branch chain to the service node 700A through the agent node 700B. When receiving the to-be-synchronized block, the service node 700A may verify the to-be-synchronized block. Since the partial block data on the basic main chain 70Q in the core consensus network is synchronized in the service node 700A, when receiving the to-be-synchronized block, the service node 700A needs to perform verification till a genesis block of the corresponding service branch chain. For example, when verifying the to-be-synchronized block (for example, the block B5) on the service branch chain 71q, the service node 700A needs to successfully find a genesis block (that is, the block header a2) of the service branch chain 71q on the basic main chain 70Q from the block B5, that is, needs to find the block header b4 based on a parent block hash value of the block B5 and then find the block b3 based on a parent block hash value of the block header b4. When the block header a2 is successfully found based on a parent block hash value of the block header b3, verification succeeds.

Certainly, if the partial block data on the basic main chain 70Q in the core consensus network is not synchronized in the service node 700A, when verifying the to-be-synchronized block on the service branch chain 71Q, the service node 700A needs not only to successfully find a genesis block (that is, the block header a2) of the service branch chain 71q on the basic main chain 70Q from the block B5 but also to find a genesis block of the basic main chain 70Q. That is, the service node 700A needs to find the block header b4 based on a parent block hash value of the block B5, then find the block b3 based on a parent block hash value of the block header b4, then successfully find the block header a2 based on a parent block hash value of the block header b3, and further successfully find the block header a1 based on a parent block hash value of the block header a2. When a block header of the genesis block is successfully found based on a parent block hash value of the block header a1, verification succeeds.

Further, when successfully verifying the to-be-synchronized block on each service branch chain, the service node 700A may write partial block data of the to-be-synchronized block (that is, block header data of the to-be-synchronized block and an associated service transaction) on each service branch chain to the corresponding service branch chain in the local blockchain.

It is to be understood that when having a supervision permission, the target consensus node in the core consensus network may obtain configuration change information (for example, a changed supervision rule) associated with the blockchain network, and further generate, based on the configuration change information, a configuration change block for writing to the basic main chain. Further, the target consensus node may broadcast the configuration change block to the core consensus network, such that the consensus node in the core consensus network performs consensus on the configuration change block. The configuration change block is used for instructing all the consensus nodes in the core consensus network to stop running. This means that when receiving the configuration change block, all the consensus nodes in the core consensus network need not only to perform consensus on the configuration change block but also to stop operations such as consensus and blocking on all the service branch chains.

The target consensus node may receive a second block consensus result returned by the consensus node in the core consensus network for the configuration change block, and further perform result analysis on the second block consensus result. If the second block consensus result indicates that consensus fails, the target consensus node may determine that configuration information is temporarily not changed in a blockchain node system corresponding to the current blockchain network, further generate resume notification information for broadcasting to the core consensus network, and broadcast the resume notification information to all the consensus nodes, such that all the consensus nodes in the core consensus network resume running. Alternatively, if the second block consensus result indicates that consensus succeeds, the target consensus node may write the configuration change block to the basic main chain. Meanwhile, the target consensus node may further perform block synchronization on all the service branch chains in the core consensus network based on the configuration change block that has been written to the basic main chain. When the configuration change block is successfully synchronized on all the service branch chains in the core consensus network, the resume notification information for broadcasting to the core consensus network is generated, and the resume notification information is further broadcast to all the consensus nodes, such that all the consensus nodes in the core consensus network resume running.

As shown in FIG. 1A, when the configuration information in the core consensus network is not changed, the current core consensus network may include the basic main chain 10Q, the service branch chain 11Q, and the service branch chain 12Q. The basic main chain 10Q may include the genesis block, the block A1, the block A2, and the block A3. The service branch chain 11Q may be a service branch chain derived from the block A2. The service branch chain 11Q may include the block B3 and the block B4. The service branch chain 12Q may be a service branch chain derived from the block A3. The service branch chain 12Q may include the block C4.

Based on this, when having the supervision permission, the target consensus node (for example, the node 120a shown in FIG. 1A) in the core consensus network may obtain configuration change information associated with the blockchain network 1W. In this case, the node 120a may obtain a block with a maximum generation timestamp (for example, the block A3) on the current basic main chain 10Q, and further determine a block hash value of the block A3 as a parent block hash value of a to-be-generated configuration change block. Further, the node 120a may perform packing processing on the parent block hash value of the configuration change block and the configuration change information to generate the configuration change block. Further, the consensus node 120a may broadcast the configuration change block to the core consensus network, such that another consensus node in the core consensus network performs consensus on the configuration change block. If the node 120a receives a second block consensus result for indicating that consensus succeeds, the node 120a may write the configuration change block to the basic main chain 10Q, that is, determine the configuration change block as a next block of the block A3 (for example, the block A4).

Meanwhile, the node 120a may further perform block synchronization respectively on all the service branch chains in the core consensus network based on the block A4. For example, after writing the configuration change block (for example, the block A4) to the basic main chain 10Q, the node 120a may perform block synchronization on the service branch chain 11Q. The node 120a may obtain a block (for example, the block B4) corresponding to a maximum generation timestamp on the service branch chain 11Q, replace the block hash value of the block A3 with a block hash value of the block B4 as the parent block hash value in the configuration change block, and further write a configuration change block after replacement to the service branch chain 11Q, that is, determine the configuration change block after replacement as a next block of the block B4 (for example, the block B5), so as to complete block synchronization on the service branch chain 11Q.

In addition, after writing the configuration change block (for example, the block A4) to the basic main chain 10Q, the node 120a further needs to perform block synchronization on the service branch chain 12Q. The node 120a may obtain a block (for example, the block C4) corresponding to a maximum generation timestamp on the service branch chain 12Q, replace the block hash value of the block A3 with a block hash value of the block C4 as the parent block hash value in the configuration change block, and further write a configuration change block after replacement to the service branch chain 12Q, that is, determine the configuration change block after replacement as a next block of the block C4 (for example, the block C5), so as to complete block synchronization on the service branch chain 12Q.

When the configuration change block is successfully synchronized on all the service branch chains (that is, the service branch chain 11Q and the service branch chain 12Q) in the core consensus network, the node 120a may generate resume notification information for broadcasting to the core consensus network, and further broadcast the resume notification information to all the consensus nodes in the core consensus network, such that all the consensus nodes in the core consensus network resume running.

Further, when the target consensus node in the core consensus network has the supervision permission, the target consensus node may further create a new transaction service on the basic main chain in the core consensus network. For example, the target consensus node may determine a next transaction service of N transaction services as a to-be-created service, and obtain service registration information associated with the to-be-created service. The service registration information may include a to-be-derived chain identifier of a to-be-derived service branch chain corresponding to the to-be-created service, service configuration information of the to-be-created service, and a derivation condition corresponding to the to-be-derived chain identifier. The to-be-derived chain identifier is different from a chain identifier corresponding to each of the N service branch chains in the core consensus network.

It may be understood that the target consensus node may obtain, from the basic main chain, a smart contract for performing branch registration on the to-be-derived service branch chain, and further invoke the smart contract to perform packing processing on the service registration information to generate a branch chain registration block for broadcasting to the core consensus network. When the branch chain registration block is successfully written to the basic main chain, the target consensus node may determine the to-be-derived service branch chain as an (N+1)^{th} service branch chain derived from the basic main chain. Thus, it can be seen that in the embodiments of this application, when the blockchain node system corresponding to the blockchain network stably runs, different transaction services may be gradually added to the blockchain node system. In this way, a transaction service corresponding to each service branch chain may be created when an adequate preparation is made, thereby effectively solving a problem of the entire system caused by desynchronization.

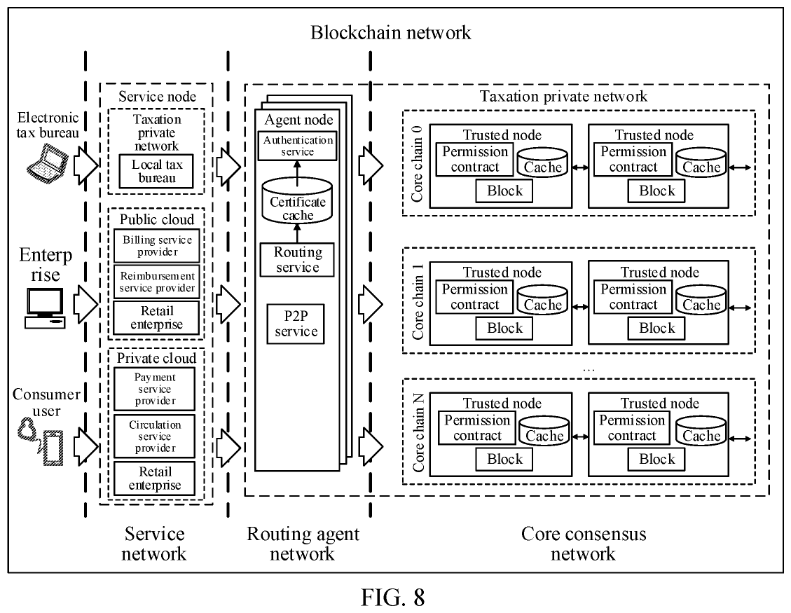

Further, refer to FIG. 8. FIG. 8 is a diagram of a system architecture of a taxation blockchain system according to an embodiment of this application. As shown in FIG. 8, in this embodiment of this application, a service network, a routing agent network, and a core consensus network form a complete blockchain service system. The core consensus network shown in FIG. 8 may include a core chain (for example, the blockchain in the core consensus network shown in FIG. 1A). The core chain may include a basic main chain in the core consensus network and N service branch chains derived from the basic main chain. N is a positive integer. Alternatively, the core consensus network shown in FIG. 8 may include an N+1 independent consensus network, specifically including a main chain independent consensus network and N branch chain independent consensus networks. One independent consensus network may include one core chain. For example, a core chain 0 may be a blockchain in the main chain independent consensus network (for example, the main chain independent consensus network W₀ shown in FIG. 1B), and a core chain 1 may be a blockchain in a branch chain independent consensus network (for example, the branch chain independent consensus network W₁ shown in FIG. 1B).

It may be understood that when the blockchain is used for some scenarios of a government (for example, a taxation system) or a commercial organization, a layered blockchain structure of “service network-core consensus network” in this embodiment of this application may be used if the blockchain system involves related data of personal privacies, national security, or the like, so as to improve confidentiality and security of the data. The diagram of the system architecture may be applied to various sub-services (transaction services) associated with a taxation service, for example, a bill service, a blocking service, a legal person service, a credit information service, and a tax refund service. One transaction service may correspond to one service branch chain. One service branch chain may correspond to one chain identifier. In this way, different transaction services can be effectively distinguished to ensure uniformity of transaction storage on a single service branch chain.

As the entire taxation service may involve a supervision organization, a drawer, a reimbursement party, a tax declaration party, and the like, service nodes in the service network shown in FIG. 8 may include a terminal device corresponding to an electronic tax bureau, a terminal device corresponding to an enterprise user, and a terminal device corresponding to a consumer user. The electronic tax bureau may be a supervision organization (for example, a computer device corresponding to a provincial, municipal, or district tax bureau) in a supervision private network. The enterprise user may be a billing service provider, a reimbursement service provider, a retail enterprise (for example, a KA enterprise, that is, a large-scale retail consumer and an important retail consumer enterprise), or the like in a public cloud. The consumer user may be a payment service provider, a circulation service provider, a retail enterprise, or the like in a private cloud. M chain identifiers may be configured for the service node in the service network. The M chain identifiers belong to chain identifiers of N service branch chains registered in the core consensus network. M may be a positive integer less than or equal to N. When performing a transaction service corresponding to any one (that is, a target chain identifier) of the M chain identifiers, service node may generate a transaction for broadcasting to the core consensus network, for an agent node in the routing agent network to forward to a target consensus node in the core consensus network, such that the target consensus node uploads the transaction to a service branch chain corresponding to the target chain identifier. The target consensus node herein may be a first consensus node with a first consensus permission or a second consensus node with a second consensus permission, and is not limited herein.

The agent node in the routing agent network may be configured to perform network isolation on the service network and the core consensus network. The agent node may have a P2P service (that is, a P2P service), a routing service, a certificate cache, and an authentication service. It may be understood that the P2P service is a service in a P2P network. Based on a specific type of network protocol, no center node is needed to maintain a network status between network nodes in the P2P network, and instead, each node performs broadcasting interaction with an adjacent node to maintain a node status of the entire network or a connection status of the adjacent node. The routing service is a basic function of the node, and may be used for communication between nodes, so as to perform network isolation on the service network and the core consensus network. The certificate cache is used for caching an identity certificate of each node. The certificate herein may be a public key infrastructure (PM). In the PM, the certificate is a proof of an identity of a public key owner, and is authorized by a certificate authority (CA). Asymmetric encryption and a digital signature of information may be implemented based on the PM. The PM herein may include public and private key passwords, an x509 certificate, a CA certificate signing center, and the like. The authentication service may be used for performing identity verification and the like on the service node in the service network. It may be understood that in this embodiment of this application, the agent node may be configured to record independent consensus node information of an independent consensus node in the core consensus network. The independent consensus node information may be used for instructing the agent node to determine, from the N branch chain independent consensus networks in the core consensus network when receiving a service request (including a transaction uploading request and a block synchronization request) transmitted by the service node in the service network, a target independent consensus network corresponding to a chain identifier carried in the service request, and further forward the service request to the target consensus node in the target independent consensus network, such that the target consensus node performs independent processing according to the chain identifier in the service request. In this case, the target consensus node is the second consensus node with the second consensus permission. Since data of the service branch chain is of a small size, and may not be fused with another service branch chain, the target consensus node may independently process the service request more conveniently.

A consensus node (that is, an accounting node) in the core consensus network may be a trusted node in a taxation private network, and may invoke a permission contract (for example, a smart contract) to determine its own consensus responsibility. The permission contract herein further stores a circulation logic about an entire life cycle of an electronic bill, for example, a bill status of the electronic bill, a circulation process, a data access permission, an application condition for the electronic bill, or an issuing condition of the electronic bill. For example, the target consensus node in the core consensus network may receive the transaction and the target chain identifier corresponding to the transaction, which are forwarded by the agent node, store, based on the target chain identifier when the transaction is successfully verified, the transaction to a cache (that is, a node transaction pool in the core consensus network) shown in FIG. 8, further perform packing processing on the transaction based on a derivation condition corresponding to the target chain identifier to obtain a to-be-verified block for broadcasting to the core consensus network, and successfully write the to-be-verified block to the service branch chain corresponding to the target chain identifier. Since each service branch chain may run simultaneously, concurrency of different transaction services is improved, and uploading waiting time of the service transactions is reduced, thereby improving resource utilization and further improving system efficiency.

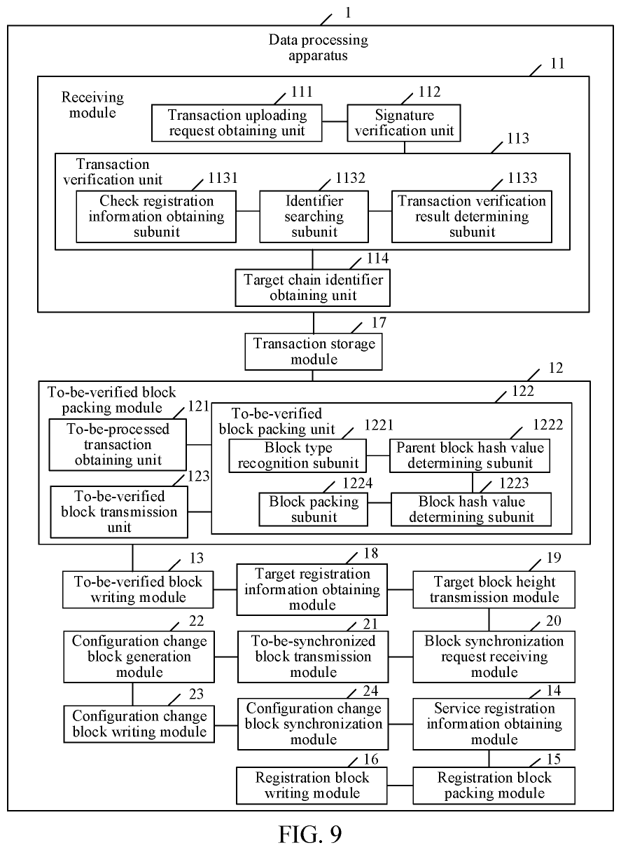

Further, refer to FIG. 9. FIG. 9 is a schematic diagram of a structure of a data processing apparatus according to an embodiment of this application. As shown in FIG. 9, the data processing apparatus 1 may be a computer-readable instruction (including program code) run in a computer device. For example, the data processing apparatus 1 is application software. The data processing apparatus 1 may be configured to perform corresponding steps in the method provided in the embodiments of this application. As shown in FIG. 9, the data processing apparatus 1 may run in a consensus node in a core consensus network. The consensus node may be a first consensus node with a first consensus permission (for example, the node 120a in the core consensus network shown in FIG. 1A) or a second consensus node with a second consensus permission (for example, a consensus node in a specific branch chain independent consensus network shown in FIG. 1B), and is not limited herein. The data processing apparatus 1 may include a receiving module 11, a to-be-verified block packing module 12, a to-be-verified block writing module 13, a service registration information obtaining module 14, a registration block packing module 15, a registration block writing module 16, a transaction storage module 17, a target registration information obtaining module 18, a target block height transmission module 19, a block synchronization request receiving module 20, a to-be-synchronized block transmission module 21, a configuration change block generation module 22, a configuration change block writing module 23, and a configuration change block synchronization module 24.

The receiving module 11 is configured to receive a transaction and a target chain identifier corresponding to the transaction, which are transmitted by a service node in a service network. The target chain identifier belongs to M chain identifiers configured by the core consensus network for the service node. The M chain identifiers belong to chain identifiers of N service branch chains registered in the core consensus network. M is a positive integer less than or equal to N. One service branch chain corresponds to one transaction service. One service branch chain corresponds to one chain identifier. Each of the N service branch chains is derived according to a derivation condition on a basic main chain in the core consensus network. Both the service network and the core consensus network are subnetworks in a blockchain network.

The receiving module 11 includes a transaction uploading request obtaining unit 111, a signature verification unit 112, a transaction verification unit 113, and a target chain identifier obtaining unit 114.

The transaction uploading request obtaining unit 111 is configured to obtain a transaction uploading request forwarded by an agent node in a routing agent network. The routing agent network is a subnetwork in the blockchain network. The routing agent network is configured to perform network isolation on the service network and the core consensus network in the blockchain network. The transaction uploading request is generated by the service node in the service network. The transaction uploading request includes the transaction, the target chain identifier corresponding to the transaction, transaction signature information corresponding to the transaction, and a node identifier of the service node. The transaction signature information is obtained by the service node by signing the transaction based on a node private key of the service node.

The signature verification unit 112 is configured to obtain a node public key of the service node, and perform signature verification on the transaction signature information based on the node public key of the service node to obtain a signature verification result.

The transaction verification unit 113 is configured to perform, when the signature verification result indicates that signature verification succeeds, transaction verification on the transaction based on the target chain identifier and the node identifier of the service node to obtain a transaction verification result.

The transaction verification unit 113 includes a check registration information obtaining subunit 1131, an identifier searching subunit 1132, and a transaction verification result determining subunit 1133.

The check registration information obtaining subunit 1131 is configured to obtain, in the case that the signature verification result indicates that signature verification succeeds, registration information associated with the service branch chain corresponding to the target chain identifier from the basic main chain, and determine the obtained registration information as check registration information.

The identifier searching subunit 1132 is configured to obtain service node configuration information in the check registration information, and search in the service node configuration information for a configured node identifier matched with the node identifier of the service node. A service node corresponding to the configured node identifier is configured by the core consensus network for the service branch chain corresponding to the target chain identifier. The service node corresponding to the configured node identifier is configured to perform a transaction service corresponding to the target chain identifier.

The transaction verification result determining subunit 1133 is configured to obtain, when the service node configuration information includes the configured node identifier matched with the node identifier of the service node, a transaction verification result for indicating that transaction verification succeeds.

Specific implementations of the check registration information obtaining subunit 1131, the identifier searching subunit 1132, and the transaction verification result determining subunit 1133 may refer to the descriptions about transaction verification on the transaction in the embodiment corresponding to FIG. 3.

The target chain identifier obtaining unit 114 is configured to determine, when the transaction verification result indicates that transaction verification succeeds, that the transaction uploading request is a valid request, and obtain the transaction and the target chain identifier from the transaction uploading request.

Specific implementations of the transaction uploading request obtaining unit 111, the signature verification unit 112, the transaction verification unit 113, and the target chain identifier obtaining unit 114 may refer to the descriptions about step S101 in the embodiment corresponding to FIG. 3.

The to-be-verified block packing module 12 is configured to perform packing processing on the transaction based on a derivation condition corresponding to the target chain identifier to obtain a to-be-verified block for broadcasting to the core consensus network, and transmit the to-be-verified block to a consensus node in the core consensus network based on the target chain identifier, such that the consensus node performs block consensus on the to-be-verified block. The derivation condition corresponding to the target chain identifier is used for determining, in the basic main chain, a genesis block of a service branch chain corresponding to the target chain identifier.

The to-be-verified block packing module 12 includes a to-be-processed transaction obtaining unit 121, a to-be-verified block packing unit 122, and a to-be-verified block transmission unit 123.

The to-be-processed transaction obtaining unit 121 is configured to obtain a service transaction with a same chain identifier as the target chain identifier from a node transaction pool of the core consensus network, and determine the obtained service transaction as a to-be-processed transaction. The to-be-processed transaction includes the transaction.

The to-be-verified block packing unit 122 is configured to perform packing processing on the to-be-processed transaction based on the derivation condition corresponding to the target chain identifier to obtain the to-be-verified block for broadcasting to the core consensus network.

The to-be-verified block packing unit 122 includes a block type recognition subunit 1221, a parent block hash value determining subunit 1222, a block hash value determining subunit 1223, and a block packing subunit 1224.

The block type recognition subunit 1221 is configured to determine the service branch chain corresponding to the target chain identifier as a target service branch chain, and recognize a block type of the to-be-verified block to be generated on the target service branch chain.

The parent block hash value determining subunit 1222 is configured to determine a parent block of the to-be-verified block based on the block type and the derivation condition corresponding to the target chain identifier, and determine a block hash value of the parent block of the to-be-verified block as a parent block hash value of the to-be-verified block.

The block type includes a first block type. The first block type is used for indicating that the parent block of the to-be-verified block is a block on the basic main chain.

The parent block hash value determining subunit 1222 is further configured to: obtain, when the block type is the first block type, target registration information associated with the target service branch chain from the basic main chain, and obtain the derivation condition corresponding to the target chain identifier from the target registration information;
determine a genesis block of the target service branch chain based on the derivation condition corresponding to the target chain identifier, and determine the determined genesis block as the parent block of the to-be-verified block; and
obtain the block hash value of the parent block of the to-be-verified block, and determine the obtained block hash value as the parent block hash value of the to-be-verified block.

The block type includes a second block type. The second block type is used for indicating that the parent block of the to-be-verified block is not a block on the basic main chain.

The parent block hash value determining subunit 1222 is further configured to: obtain, when the block type is the second block type, a block with a maximum generation timestamp from the target service branch chain indicated by the derivation condition corresponding to the target chain identifier, and determine the block with the maximum generation timestamp as the parent block of the to-be-verified block; and obtain the block hash value of the parent block of the to-be-verified block, and determine the obtained block hash value as the parent block hash value of the to-be-verified block.

The block hash value determining subunit 1223 is configured to perform transaction hash transformation on the to-be-processed transaction to obtain a transaction hash value corresponding to the to-be-processed transaction, and determine a block hash value of the to-be-verified block based on the transaction hash value.

The block packing subunit 1224 is configured to perform packing processing on the to-be-processed transaction, the block hash value, and the parent block hash value to obtain the to-be-verified block to be written to the target service branch chain.

Specific implementations of the block type recognition subunit 1221, the parent block hash value determining subunit 1222, the block hash value determining subunit 1223, and the block packing subunit 1224 may refer to the descriptions about the to-be-verified block in the embodiment corresponding to FIG. 3.

The to-be-verified block transmission unit 123 is configured to transmit the to-be-verified block to a part consensus node in the core consensus network based on the target chain identifier. The consensus node is configured to perform consensus on a transaction service corresponding to the target chain identifier.

Specific implementations of the to-be-processed transaction obtaining unit 121, the to-be-verified block packing unit 122, and the to-be-verified block transmission unit 123 may refer to the descriptions about step S102 in the embodiment corresponding to FIG. 3.

The to-be-verified block writing module 13 is configured to receive a first block consensus result returned by the consensus node for the to-be-verified block, and write, based on the genesis block when the first block consensus result indicates that consensus succeeds, the to-be-verified block to the service branch chain corresponding to the target chain identifier.

The service registration information obtaining module 14 is configured to determine a next transaction service of N transaction services as a to-be-created service, and obtain service registration information associated with the to-be-created service. The service registration information includes a to-be-derived chain identifier of a to-be-derived service branch chain corresponding to the to-be-created service, service configuration information of the to-be-created service, and a derivation condition corresponding to the to-be-derived chain identifier. The to-be-derived chain identifier is different from a chain identifier corresponding to each of the N service branch chains.

The registration block packing module 15 is configured to obtain, from the basic main chain, a smart contract for performing branch registration on the to-be-derived service branch chain, and invoke the smart contract to perform packing processing on the service registration information to generate a branch chain registration block for broadcasting to the core consensus network.

The registration block writing module 16 is configured to determine, when the branch chain registration block is successfully written to the basic main chain, the to-be-derived service branch chain as an (N+1)th service branch chain derived from the basic main chain.

The target consensus node has a first consensus permission. A node transaction pool of the target consensus node includes N transaction sets. One transaction set is used for storing a service transaction with a same chain identifier.

The transaction storage module 17 is configured to determine, in the case that the transaction verification result indicates that transaction verification succeeds, a target transaction set corresponding to the target chain identifier from the N transaction sets, and store the transaction to the target transaction set.

The target registration information obtaining module 18 is configured to obtain, when the to-be-verified block is successfully written to the service branch chain corresponding to the target chain identifier, target registration information associated with the service branch chain corresponding to the target chain identifier from the basic main chain, and obtain service node configuration information corresponding to the target chain identifier from the target registration information.

The target block height transmission module 19 is configured to transmit the service node configuration information and a target block height of the to-be-verified block to an agent node in a routing agent network, such that the agent node forwards the target block height to a service node corresponding to a configured node identifier in the service node configuration information. The target block height is used for instructing the service node corresponding to the configured node identifier to generate a block synchronization request based on an initial block height on a local blockchain and a chain identifier corresponding to the initial block height. The routing agent network is a subnetwork in the blockchain network. The routing agent network is configured to perform network isolation on the service network and the core consensus network.

The block synchronization request receiving module 20 is configured to receive the block synchronization request through the agent node, and determine, based on the initial block height and the chain identifier corresponding to the initial block height in the block synchronization request, a to-be-synchronized block for synchronization to the service node corresponding to the configured node identifier.

The to-be-synchronized block transmission module 21 is configured to transmit the to-be-synchronized block to the service node corresponding to the configured node identifier through the agent node, such that the service node corresponding to the configured node identifier writes the to-be-synchronized block to a corresponding service branch chain in the local blockchain when the to-be-synchronized block is successfully verified.

The configuration change block generation module 22 is configured to obtain, when there is a supervision permission, configuration change information associated with the blockchain network, generate, based on the configuration change information, a configuration change block for writing to the basic main chain, and broadcast the configuration change block to the core consensus network, such that the consensus node in the core consensus network performs consensus on the configuration change block. The configuration change block is used for instructing all consensus nodes in the core consensus network to stop running.

The configuration change block writing module 23 is configured to receive a second block consensus result returned by the consensus node for the configuration change block, and write, when the second block consensus result indicates that consensus succeeds, the configuration change block to the basic main chain.

The configuration change block synchronization module 24 is configured to perform block synchronization respectively on all service branch chains in the core consensus network based on the configuration change block, generate, when the configuration change block is successfully synchronized on all the service branch chains, resume notification information for broadcasting to the core consensus network, and broadcast the resume notification information to all the consensus nodes, such that all the consensus nodes resume running.

The blockchain network includes a routing agent network. An agent node in the routing agent network is configured to record independent consensus node information of an independent consensus node in the core consensus network. The independent consensus node information is used for instructing the agent node to determine, from N branch chain independent consensus networks in the core consensus network in response to receiving a service request transmitted by the service node, a target independent consensus network corresponding to a chain identifier carried in the service request, and forward the service request to the target consensus node with a second consensus permission in the target independent consensus network. The service request includes a transaction uploading request. The transaction uploading request carries the transaction and the target chain identifier corresponding to the transaction.

Specific implementations of the receiving module 11, the to-be-verified block packing module 12, the to-be-verified block writing module 13, the service registration information obtaining module 14, the registration block packing module 15, the registration block writing module 16, the transaction storage module 17, the target registration information obtaining module 18, the target block height transmission module 19, the block synchronization request receiving module 20, the to-be-synchronized block transmission module 21, the configuration change block generation module 22, the configuration change block writing module 23, and the configuration change block synchronization module 24 may refer to the descriptions about step S201 to step S207 in the embodiment corresponding to FIG. 6.

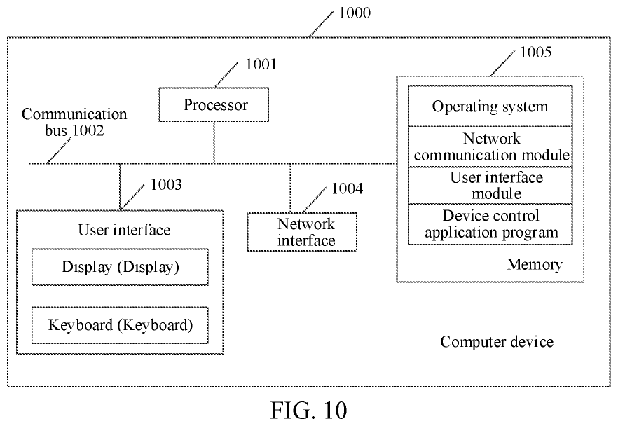

Further, refer to FIG. 10. FIG. 10 is a schematic diagram of a computer device according to an embodiment of this application. As shown in FIG. 10, the computer device 1000 may be a target consensus node in a core consensus network. The target consensus node may be a first consensus node with a first consensus permission (for example, the node 120a in the core consensus network shown in FIG. 1A) or a second consensus node with a second consensus permission (for example, a consensus node in any branch chain independent consensus network shown in FIG. 1B), and is not described again herein. The computer device 1000 may include at least one processor 1001, for example, a central processing unit (CPU), at least one network interface 1004, a user interface 1003, a memory 1005, and at least one communication bus 1002. The communication bus 1002 is configured to implement connection communication between these components. The user interface 1003 may include a display and a keyboard. Alternatively, the network interface 1004 may include a standard wired interface and wireless interface (for example, a wireless fidelity (WI-FI) interface). The memory 1005 may be a high-speed random access memory (RAM), or a non-volatile memory, for example, at least one disk memory. Alternatively, the memory 1005 may be at least one storage apparatus far away from the processor 1001. As shown in FIG. 10, as a computer storage medium, the memory 1005 may include an operating system, a network communication module, a user interface module, and a device control application program.

In the computer device 1000 shown in FIG. 10, the network interface 1004 is mainly configured for network communication with an agent node in a routing agent network and another consensus node in the core consensus network. The user interface 1003 is mainly configured to provide an input interface for a user. The processor 1001 may be configured to invoke the device control application program stored in the memory 1005 to implement:
receiving a transaction and a target chain identifier corresponding to the transaction, which are transmitted by a service node in a service network, the target chain identifier belonging to M chain identifiers configured by the core consensus network for the service node, the M chain identifiers belonging to chain identifiers of N service branch chains registered in the core consensus network, M being a positive integer less than or equal to N, one service branch chain corresponding to one transaction service, one service branch chain corresponding to one chain identifier, each of the N service branch chains being derived according to a derivation condition on a basic main chain in the core consensus network, and both the service network and the core consensus network being subnetworks in a blockchain network;
performing packing processing on the transaction based on a derivation condition corresponding to the target chain identifier to obtain a to-be-verified block for broadcasting to the core consensus network, and transmitting the to-be-verified block to a consensus node in the core consensus network based on the target chain identifier, such that the consensus node performs block consensus on the to-be-verified block, the derivation condition corresponding to the target chain identifier being used for determining, in the basic main chain, a genesis block of a service branch chain corresponding to the target chain identifier; and
receiving a first block consensus result returned by the consensus node for the to-be-verified block, and writing, based on the genesis block when the first block consensus result indicates that consensus succeeds, the to-be-verified block to the service branch chain corresponding to the target chain identifier.

It is to be understood that the computer device 1000 described in this embodiment of this application may execute the descriptions about the data processing methods in the embodiments corresponding to FIG. 3 and FIG. 6, or execute the descriptions about the data processing apparatus 1 in the embodiment corresponding to FIG. 9.

An embodiment of this application also provides one or more non-transitory computer-readable storage media. The computer-readable storage medium stores computer-readable instructions. The computer-readable instructions include program instructions. The program instructions are executed by a processor to implement the data processing methods including each step in FIG. 3 and FIG. 6, specifically referring to the implementation provided in each step in FIG. 3 and FIG. 6.

The computer-readable storage medium may be an internal storage unit of the data processing apparatus or the computer device provided in any one of the foregoing embodiments, such as a hard disk or an internal memory of the computer device. The computer-readable storage medium may alternatively be an external storage device of the computer device, such as a plug-in hard disk, a smart media card (SMC), a secure digital (SD) card, or a flash card on the computer device. Further, the computer-readable storage medium may alternatively include both an internal storage unit and an external storage device of the computer device. The computer-readable storage medium is configured to store the computer-readable instructions and another program and data that are needed by the computer device. The computer-readable storage medium may further be configured to temporarily store data that has been outputted or is to be output.

An aspect of this application provides a computer program product. The computer program product includes computer-readable instructions. The computer-readable instructions are stored in a computer-readable storage medium. One or more processors of a computer device read the computer-readable instructions from the computer-readable storage medium. The one or more processors execute the computer-readable instructions, such that the computer device execute the descriptions about the data processing method in the embodiment corresponding to FIG. 3 or FIG. 6.

It may be understood by a person of ordinary skill in the art that all or some processes in the method of the foregoing embodiments may be completed by computer-readable instructions by instructing related hardware. The program may be stored in a computer-readable storage medium. When the program is executed, the processes of each method embodiment may be included. The storage medium may be a magnetic disk, an optical disk, a read-only memory (ROM), a RAM, or the like.

The above is only the preferred embodiment of this application and certainly not intended to limit the scope of this application. Therefore, equivalent variations made according to the claims of this application also fall within the scope of this application.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A data processing method performed by a computer device acting as a target consensus node in a core consensus network. The method comprising:
receiving a transaction and a target chain identifier corresponding to the transaction, which are transmitted by a service node in a service network, the target chain identifier belonging to M chain identifiers configured by the core consensus network for the service node, the M chain identifiers belonging to chain identifiers of N service branch chains registered in the core consensus network, M being a positive integer less than or equal to N, one service branch chain corresponding to one transaction service, one service branch chain corresponding to one chain identifier, each of the N service branch chains being derived according to a derivation condition on a basic main chain in the core consensus network, and both the service network and the core consensus network being subnetworks in a blockchain network;
performing packing processing on the transaction based on a derivation condition corresponding to the target chain identifier to obtain a to-be-verified block for broadcasting to the core consensus network, and transmitting the to-be-verified block to at least a part of consensus nodes in the core consensus network except the target consensus node based on the target chain identifier, such that the consensus node performs block consensus on the to-be-verified block, the derivation condition corresponding to the target chain identifier being used for determining, in the basic main chain, a genesis block of a service branch chain corresponding to the target chain identifier; and
receiving a first block consensus result returned by the consensus node for the to-be-verified block, and writing, based on the genesis block when the first block consensus result indicates that consensus succeeds, the to-be-verified block to the service branch chain corresponding to the target chain identifier.

2. The method according to claim 1, wherein the method further comprises:
determining a next transaction service of N transaction services as a to-be-created service, and obtaining service registration information associated with the to-be-created service, the service registration information comprising a to-be-derived chain identifier of a to-be-derived service branch chain corresponding to the to-be-created service, service configuration information of the to-be-created service, and a derivation condition corresponding to the to-be-derived chain identifier, and the to-be-derived chain identifier being different from a chain identifier corresponding to each of the N service branch chains;
obtaining, from the basic main chain, a smart contract for performing branch registration on the to-be-derived service branch chain, and invoking the smart contract to perform packing processing on the service registration information to generate a branch chain registration block for broadcasting to the core consensus network; and
determining, when the branch chain registration block is successfully written to the basic main chain, the to-be-derived service branch chain as an (N+1)th service branch chain derived from the basic main chain.

3. The method according to claim 1, wherein the receiving a transaction and a target chain identifier corresponding to the transaction, which are transmitted by a service node in a service network comprises:
obtaining a transaction uploading request forwarded by an agent node in a routing agent network, the routing agent network being a subnetwork in the blockchain network, the routing agent network being configured to perform network isolation on the service network and the core consensus network in the blockchain network, the transaction uploading request being generated by the service node in the service network, the transaction uploading request comprising the transaction, the target chain identifier corresponding to the transaction, transaction signature information corresponding to the transaction, and a node identifier of the service node, and the transaction signature information being obtained by the service node by signing the transaction based on a node private key of the service node;
obtaining a node public key of the service node, and performing signature verification on the transaction signature information based on the node public key of the service node to obtain a signature verification result;
performing, when the signature verification result indicates that signature verification succeeds, transaction verification on the transaction based on the target chain identifier and the node identifier of the service node to obtain a transaction verification result; and
determining, when the transaction verification result indicates that transaction verification succeeds, that the transaction uploading request is a valid request, and obtaining the transaction and the target chain identifier from the transaction uploading request.

4. The method according to claim 1, wherein the performing packing processing on the transaction based on a derivation condition corresponding to the target chain identifier to obtain a to-be-verified block for broadcasting to the core consensus network and transmitting the to-be-verified block to at least a part of consensus nodes in the core consensus network except the target consensus node based on the target chain identifier comprises:
obtaining a service transaction with a same chain identifier as the target chain identifier from a node transaction pool of the core consensus network, and determining the obtained service transaction as a to-be-processed transaction, the to-be-processed transaction comprising the transaction;
performing packing processing on the to-be-processed transaction based on the derivation condition corresponding to the target chain identifier to obtain the to-be-verified block for broadcasting to the core consensus network; and
transmitting the to-be-verified block to at least a part of consensus nodes in the core consensus network except the target consensus node based on the target chain identifier, the consensus node being configured to perform consensus on a transaction service corresponding to the target chain identifier.

5. The method according to claim 1, wherein the method further comprises:
obtaining, when the to-be-verified block is successfully written to the service branch chain corresponding to the target chain identifier, target registration information associated with the service branch chain corresponding to the target chain identifier from the basic main chain, and obtaining service node configuration information corresponding to the target chain identifier from the target registration information;
transmitting the service node configuration information and a target block height of the to-be-verified block to an agent node in a routing agent network, such that the agent node forwards the target block height to a service node corresponding to a configured node identifier in the service node configuration information, the target block height being used for instructing the service node corresponding to the configured node identifier to generate a block synchronization request based on an initial block height on a local blockchain and a chain identifier corresponding to the initial block height, the routing agent network being a subnetwork in the blockchain network, and the routing agent network being configured to perform network isolation on the service network and the core consensus network;
receiving the block synchronization request through the agent node, and determining, based on the initial block height and the chain identifier corresponding to the initial block height in the block synchronization request, a to-be-synchronized block for synchronization to the service node corresponding to the configured node identifier; and
transmitting the to-be-synchronized block to the service node corresponding to the configured node identifier through the agent node, such that the service node corresponding to the configured node identifier writes the to-be-synchronized block to a corresponding service branch chain in the local blockchain when the to-be-synchronized block is successfully verified.

6. The method according to claim 1, wherein the method further comprises:
obtaining, when there is a supervision permission, configuration change information associated with the blockchain network, generating, based on the configuration change information, a configuration change block for writing to the basic main chain, and broadcasting the configuration change block to the core consensus network, such that the consensus node in the core consensus network performs consensus on the configuration change block, the configuration change block being used for instructing all consensus nodes in the core consensus network to stop running;
receiving a second block consensus result returned by the consensus node for the configuration change block, and writing, when the second block consensus result indicates that consensus succeeds, the configuration change block to the basic main chain; and
performing block synchronization respectively on all service branch chains in the core consensus network based on the configuration change block, generating, when the configuration change block is successfully synchronized on all the service branch chains, resume notification information for broadcasting to the core consensus network, and broadcasting the resume notification information to all the consensus nodes, such that all the consensus nodes resume running.

7. The method according to claim 1, wherein the blockchain network comprises a routing agent network; an agent node in the routing agent network is configured to record independent consensus node information of an independent consensus node in the core consensus network; the independent consensus node information is used for instructing the agent node to determine, from N branch chain independent consensus networks in the core consensus network in response to receiving a service request transmitted by the service node, a target independent consensus network corresponding to a chain identifier carried in the service request, and forward the service request to the target consensus node with a second consensus permission in the target independent consensus network; the service request comprises a transaction uploading request; and the transaction uploading request carries the transaction and the target chain identifier corresponding to the transaction.

8. A computer device acting as a target consensus node in a core consensus network, the computer device comprising: one or more processors and a memory,
the processor being connected to the memory, the memory being configured to store computer-readable instructions that, when executed by the one or more processors, cause the computer device to perform a data processing method including:
receiving a transaction and a target chain identifier corresponding to the transaction, which are transmitted by a service node in a service network, the target chain identifier belonging to M chain identifiers configured by the core consensus network for the service node, the M chain identifiers belonging to chain identifiers of N service branch chains registered in the core consensus network, M being a positive integer less than or equal to N, one service branch chain corresponding to one transaction service, one service branch chain corresponding to one chain identifier, each of the N service branch chains being derived according to a derivation condition on a basic main chain in the core consensus network, and both the service network and the core consensus network being subnetworks in a blockchain network;
performing packing processing on the transaction based on a derivation condition corresponding to the target chain identifier to obtain a to-be-verified block for broadcasting to the core consensus network, and transmitting the to-be-verified block to at least a part of consensus nodes in the core consensus network except the target consensus node based on the target chain identifier, such that the consensus node performs block consensus on the to-be-verified block, the derivation condition corresponding to the target chain identifier being used for determining, in the basic main chain, a genesis block of a service branch chain corresponding to the target chain identifier; and
receiving a first block consensus result returned by the consensus node for the to-be-verified block, and writing, based on the genesis block when the first block consensus result indicates that consensus succeeds, the to-be-verified block to the service branch chain corresponding to the target chain identifier.

9. The computer device according to claim 8, wherein the method further comprises:
determining a next transaction service of N transaction services as a to-be-created service, and obtaining service registration information associated with the to-be-created service, the service registration information comprising a to-be-derived chain identifier of a to-be-derived service branch chain corresponding to the to-be-created service, service configuration information of the to-be-created service, and a derivation condition corresponding to the to-be-derived chain identifier, and the to-be-derived chain identifier being different from a chain identifier corresponding to each of the N service branch chains;
obtaining, from the basic main chain, a smart contract for performing branch registration on the to-be-derived service branch chain, and invoking the smart contract to perform packing processing on the service registration information to generate a branch chain registration block for broadcasting to the core consensus network; and
determining, when the branch chain registration block is successfully written to the basic main chain, the to-be-derived service branch chain as an (N+1)th service branch chain derived from the basic main chain.

10. The computer device according to claim 8, wherein the receiving a transaction and a target chain identifier corresponding to the transaction, which are transmitted by a service node in a service network comprises:
obtaining a transaction uploading request forwarded by an agent node in a routing agent network, the routing agent network being a subnetwork in the blockchain network, the routing agent network being configured to perform network isolation on the service network and the core consensus network in the blockchain network, the transaction uploading request being generated by the service node in the service network, the transaction uploading request comprising the transaction, the target chain identifier corresponding to the transaction, transaction signature information corresponding to the transaction, and a node identifier of the service node, and the transaction signature information being obtained by the service node by signing the transaction based on a node private key of the service node;
obtaining a node public key of the service node, and performing signature verification on the transaction signature information based on the node public key of the service node to obtain a signature verification result;
performing, when the signature verification result indicates that signature verification succeeds, transaction verification on the transaction based on the target chain identifier and the node identifier of the service node to obtain a transaction verification result; and
determining, when the transaction verification result indicates that transaction verification succeeds, that the transaction uploading request is a valid request, and obtaining the transaction and the target chain identifier from the transaction uploading request.

11. The computer device according to claim 8, wherein the performing packing processing on the transaction based on a derivation condition corresponding to the target chain identifier to obtain a to-be-verified block for broadcasting to the core consensus network and transmitting the to-be-verified block to at least a part of consensus nodes in the core consensus network except the target consensus node based on the target chain identifier comprises:
obtaining a service transaction with a same chain identifier as the target chain identifier from a node transaction pool of the core consensus network, and determining the obtained service transaction as a to-be-processed transaction, the to-be-processed transaction comprising the transaction;
performing packing processing on the to-be-processed transaction based on the derivation condition corresponding to the target chain identifier to obtain the to-be-verified block for broadcasting to the core consensus network; and
transmitting the to-be-verified block to at least a part of consensus nodes in the core consensus network except the target consensus node based on the target chain identifier, the consensus node being configured to perform consensus on a transaction service corresponding to the target chain identifier.

12. The computer device according to claim 8, wherein the method further comprises:
obtaining, when the to-be-verified block is successfully written to the service branch chain corresponding to the target chain identifier, target registration information associated with the service branch chain corresponding to the target chain identifier from the basic main chain, and obtaining service node configuration information corresponding to the target chain identifier from the target registration information;
transmitting the service node configuration information and a target block height of the to-be-verified block to an agent node in a routing agent network, such that the agent node forwards the target block height to a service node corresponding to a configured node identifier in the service node configuration information, the target block height being used for instructing the service node corresponding to the configured node identifier to generate a block synchronization request based on an initial block height on a local blockchain and a chain identifier corresponding to the initial block height, the routing agent network being a subnetwork in the blockchain network, and the routing agent network being configured to perform network isolation on the service network and the core consensus network;
receiving the block synchronization request through the agent node, and determining, based on the initial block height and the chain identifier corresponding to the initial block height in the block synchronization request, a to-be-synchronized block for synchronization to the service node corresponding to the configured node identifier; and
transmitting the to-be-synchronized block to the service node corresponding to the configured node identifier through the agent node, such that the service node corresponding to the configured node identifier writes the to-be-synchronized block to a corresponding service branch chain in the local blockchain when the to-be-synchronized block is successfully verified.

13. The computer device according to claim 8, wherein the method further comprises:
obtaining, when there is a supervision permission, configuration change information associated with the blockchain network, generating, based on the configuration change information, a configuration change block for writing to the basic main chain, and broadcasting the configuration change block to the core consensus network, such that the consensus node in the core consensus network performs consensus on the configuration change block, the configuration change block being used for instructing all consensus nodes in the core consensus network to stop running;
receiving a second block consensus result returned by the consensus node for the configuration change block, and writing, when the second block consensus result indicates that consensus succeeds, the configuration change block to the basic main chain; and
performing block synchronization respectively on all service branch chains in the core consensus network based on the configuration change block, generating, when the configuration change block is successfully synchronized on all the service branch chains, resume notification information for broadcasting to the core consensus network, and broadcasting the resume notification information to all the consensus nodes, such that all the consensus nodes resume running.

14. The computer device according to claim 8, wherein the blockchain network comprises a routing agent network; an agent node in the routing agent network is configured to record independent consensus node information of an independent consensus node in the core consensus network; the independent consensus node information is used for instructing the agent node to determine, from N branch chain independent consensus networks in the core consensus network in response to receiving a service request transmitted by the service node, a target independent consensus network corresponding to a chain identifier carried in the service request, and forward the service request to the target consensus node with a second consensus permission in the target independent consensus network; the service request comprises a transaction uploading request; and the transaction uploading request carries the transaction and the target chain identifier corresponding to the transaction.

15. One or more non-transitory computer-readable storage media, storing computer-readable instructions that, when executed by one or more processors of a computer device acting as a target consensus node in a core consensus network, cause the computer device to perform a data processing method including:
receiving a transaction and a target chain identifier corresponding to the transaction, which are transmitted by a service node in a service network, the target chain identifier belonging to M chain identifiers configured by the core consensus network for the service node, the M chain identifiers belonging to chain identifiers of N service branch chains registered in the core consensus network, M being a positive integer less than or equal to N, one service branch chain corresponding to one transaction service, one service branch chain corresponding to one chain identifier, each of the N service branch chains being derived according to a derivation condition on a basic main chain in the core consensus network, and both the service network and the core consensus network being subnetworks in a blockchain network;
performing packing processing on the transaction based on a derivation condition corresponding to the target chain identifier to obtain a to-be-verified block for broadcasting to the core consensus network, and transmitting the to-be-verified block to at least a part of consensus nodes in the core consensus network except the target consensus node based on the target chain identifier, such that the consensus node performs block consensus on the to-be-verified block, the derivation condition corresponding to the target chain identifier being used for determining, in the basic main chain, a genesis block of a service branch chain corresponding to the target chain identifier; and
receiving a first block consensus result returned by the consensus node for the to-be-verified block, and writing, based on the genesis block when the first block consensus result indicates that consensus succeeds, the to-be-verified block to the service branch chain corresponding to the target chain identifier.

16. The non-transitory computer-readable storage media according to claim 15, wherein the method further comprises:
determining a next transaction service of N transaction services as a to-be-created service, and obtaining service registration information associated with the to-be-created service, the service registration information comprising a to-be-derived chain identifier of a to-be-derived service branch chain corresponding to the to-be-created service, service configuration information of the to-be-created service, and a derivation condition corresponding to the to-be-derived chain identifier, and the to-be-derived chain identifier being different from a chain identifier corresponding to each of the N service branch chains;
obtaining, from the basic main chain, a smart contract for performing branch registration on the to-be-derived service branch chain, and invoking the smart contract to perform packing processing on the service registration information to generate a branch chain registration block for broadcasting to the core consensus network; and
determining, when the branch chain registration block is successfully written to the basic main chain, the to-be-derived service branch chain as an (N+1)th service branch chain derived from the basic main chain.

17. The non-transitory computer-readable storage media according to claim 15, wherein the receiving a transaction and a target chain identifier corresponding to the transaction, which are transmitted by a service node in a service network comprises:
obtaining a transaction uploading request forwarded by an agent node in a routing agent network, the routing agent network being a subnetwork in the blockchain network, the routing agent network being configured to perform network isolation on the service network and the core consensus network in the blockchain network, the transaction uploading request being generated by the service node in the service network, the transaction uploading request comprising the transaction, the target chain identifier corresponding to the transaction, transaction signature information corresponding to the transaction, and a node identifier of the service node, and the transaction signature information being obtained by the service node by signing the transaction based on a node private key of the service node;
obtaining a node public key of the service node, and performing signature verification on the transaction signature information based on the node public key of the service node to obtain a signature verification result;
performing, when the signature verification result indicates that signature verification succeeds, transaction verification on the transaction based on the target chain identifier and the node identifier of the service node to obtain a transaction verification result; and
determining, when the transaction verification result indicates that transaction verification succeeds, that the transaction uploading request is a valid request, and obtaining the transaction and the target chain identifier from the transaction uploading request.

18. The non-transitory computer-readable storage media according to claim 15, wherein the performing packing processing on the transaction based on a derivation condition corresponding to the target chain identifier to obtain a to-be-verified block for broadcasting to the core consensus network and transmitting the to-be-verified block to at least a part of consensus nodes in the core consensus network except the target consensus node based on the target chain identifier comprises:
obtaining a service transaction with a same chain identifier as the target chain identifier from a node transaction pool of the core consensus network, and determining the obtained service transaction as a to-be-processed transaction, the to-be-processed transaction comprising the transaction;
performing packing processing on the to-be-processed transaction based on the derivation condition corresponding to the target chain identifier to obtain the to-be-verified block for broadcasting to the core consensus network; and
transmitting the to-be-verified block to at least a part of consensus nodes in the core consensus network except the target consensus node based on the target chain identifier, the consensus node being configured to perform consensus on a transaction service corresponding to the target chain identifier.

19. The non-transitory computer-readable storage media according to claim 15, wherein the method further comprises:
obtaining, when the to-be-verified block is successfully written to the service branch chain corresponding to the target chain identifier, target registration information associated with the service branch chain corresponding to the target chain identifier from the basic main chain, and obtaining service node configuration information corresponding to the target chain identifier from the target registration information;
transmitting the service node configuration information and a target block height of the to-be-verified block to an agent node in a routing agent network, such that the agent node forwards the target block height to a service node corresponding to a configured node identifier in the service node configuration information, the target block height being used for instructing the service node corresponding to the configured node identifier to generate a block synchronization request based on an initial block height on a local blockchain and a chain identifier corresponding to the initial block height, the routing agent network being a subnetwork in the blockchain network, and the routing agent network being configured to perform network isolation on the service network and the core consensus network;
receiving the block synchronization request through the agent node, and determining, based on the initial block height and the chain identifier corresponding to the initial block height in the block synchronization request, a to-be-synchronized block for synchronization to the service node corresponding to the configured node identifier; and
transmitting the to-be-synchronized block to the service node corresponding to the configured node identifier through the agent node, such that the service node corresponding to the configured node identifier writes the to-be-synchronized block to a corresponding service branch chain in the local blockchain when the to-be-synchronized block is successfully verified.

20. The non-transitory computer-readable storage media according to claim 15, wherein the method further comprises:
obtaining, when there is a supervision permission, configuration change information associated with the blockchain network, generating, based on the configuration change information, a configuration change block for writing to the basic main chain, and broadcasting the configuration change block to the core consensus network, such that the consensus node in the core consensus network performs consensus on the configuration change block, the configuration change block being used for instructing all consensus nodes in the core consensus network to stop running;
receiving a second block consensus result returned by the consensus node for the configuration change block, and writing, when the second block consensus result indicates that consensus succeeds, the configuration change block to the basic main chain; and
performing block synchronization respectively on all service branch chains in the core consensus network based on the configuration change block, generating, when the configuration change block is successfully synchronized on all the service branch chains, resume notification information for broadcasting to the core consensus network, and broadcasting the resume notification information to all the consensus nodes, such that all the consensus nodes resume running.

21. The non-transitory computer-readable storage media according to claim 15, wherein the blockchain network comprises a routing agent network; an agent node in the routing agent network is configured to record independent consensus node information of an independent consensus node in the core consensus network; the independent consensus node information is used for instructing the agent node to determine, from N branch chain independent consensus networks in the core consensus network in response to receiving a service request transmitted by the service node, a target independent consensus network corresponding to a chain identifier carried in the service request, and forward the service request to the target consensus node with a second consensus permission in the target independent consensus network; the service request comprises a transaction uploading request; and the transaction uploading request carries the transaction and the target chain identifier corresponding to the transaction.
